(19) United States
(12) Patent Application Publication
(10) Pub. No.: US 2005/0157581 A1
(43) Pub. Date: Jul. 21, 2005

(54) Display device, data driving circuit, and display panel driving method

(75) Inventors: Tomoyuki Shiurasaki, Tokyo (JP); Kazuhito Sato, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 11/035,269

(22) Filed: Jan. 12, 2005

(30) Foreign Application Priority Data
Jan. 16, 2004 (JP) 2004-009146

(51) Int. Cl. G11C 8/00

(52) U.S. Cl. 365/230.06

(57) ABSTRACT

A display device includes a plurality of selection scan lines, a plurality of current lines, a selection scan driver which sequentially selects the plurality of selection scan lines in each selection period, a data driving circuit which applies a reset voltage to the plurality of current lines in the selection period and supplies a designating current having a current value corresponding to an image signal to the plurality of current lines after applying the reset voltage, and a plurality of pixel circuits which are connected to the plurality of selection scan lines and the plurality of current lines, and supply a driving current having a current value corresponding to the current value of the designating current which flows through the plurality of current lines.

### CROSS-REFERENCE TO RELATED APPLICATIONS

This application is based upon and claims the benefit of priority from prior Japanese Patent Application No. 2004-009146, filed Jan. 16, 2004, the entire contents of which are incorporated herein by reference.

### BACKGROUND OF THE INVENTION

1. Field of the Invention

The present invention relates to a display panel driving method of driving a display panel including a light-emitting element for each pixel, a data driving circuit for driving the display panel, and a display device including the display panel, the data driving circuit, and a selection scan driver.

2. Description of the Related Art

Generally, liquid crystal displays are classified into active matrix driving type liquid crystal displays and simple matrix driving type liquid crystal displays. The active matrix driving type liquid crystal displays display images having contrast and resolution higher than those displayed by the simple matrix driving type liquid crystal displays. In the active matrix driving type liquid crystal display, a liquid crystal element which also functions as a capacitor, and a transistor which functions as a pixel switching element are formed for each pixel. In the active matrix driving system, when a voltage at a level representing luminance is applied to a current line by a data driver while a scan line is selected by a scan driver serving as a shift register, this voltage is applied to the liquid crystal element via the transistor. Even when the transistor is turned off in a period after the selection of the scan line is complete and before the scan line is selected again, the liquid crystal element functions as a capacitor, so the voltage level is held in this period. As described above, the light transmittance of the liquid crystal element is refreshed while the scan line is selected, and light from a backlight is transmitted through the liquid crystal element having the refreshed light transmittance. In this manner, the liquid crystal display expresses a tone.

Displays using organic EL (ElecctroLuminescent) elements as self-light-emitting elements require no such a backlight as used in the liquid crystal displays, and hence are optimum for flat display devices. In addition, the viewing angle is not limited unlike in the liquid crystal display. Therefore, these organic EL displays are increasingly expected to be put into practical use as next-generation display devices.

From the viewpoints of high luminance, high contrast, and high resolution, active matrix driving type organic EL displays are developed similarly to the liquid crystal displays. For example, in the conventional active matrix driving type organic EL display described in Jpn. Pat. Appln. KOKAI Publication No. 2000-221942, a pixel circuit (referred to as an organic EL element driving circuit in patent reference 1) is formed for each pixel. This pixel circuit includes an organic EL element, driving TFT, first switching element, switching TFT, and the like. When a control line is selected, a current source driver applies a voltage as luminance data to the gate of the driving TFT. Consequently, the driving TFT is turned on, and a driving current having a current value corresponding to the level of the gate voltage flows from a power supply line to the driving TFT via the organic EL element, so the organic EL element emits light at luminance corresponding to the current value of the electric current. When the selection of the control line is complete, the gate voltage of the driving TFT is held by the first switching element, so the emission of the organic EL element is also held. When a blanking signal is input to the gate of the switching TFT after that, the gate voltage of the driving TFT decreases to turn it off, and the organic EL element is also turned off to complete one frame period.

Generally, the channel resistance of a transistor changes in accordance with a change in ambient temperature, or changes when the transistor is used for a long time. As a consequence, the gate threshold voltage changes with time, or differs from one transistor to another. Therefore, in the conventional voltage-controlled, active matrix driving type organic EL display in which the luminance and tone are controlled by the signal voltage, it is difficult to uniquely designate the current value of an electric current which flows through the organic EL element by the level of the gate voltage of the driving TFT, even if the current value of the electric current which flows through the organic EL element is changed by changing the level of the gate voltage of the driving TFT by using the signal voltage from the current line. That is, even when the gate voltage having the same level is applied to the driving TFTs of a plurality of pixels, the luminance of the organic EL element changes from one pixel to another. This produces variations in luminance on the display screen. Also, since the driving TFT deteriorates with time, the same gate voltage as the initial gate voltage cannot generate a driving current having the same current value as the initial current value. This also varies the luminance of the organic EL elements.

### BRIEF SUMMARY OF THE INVENTION

It is, therefore, an object of the present invention to provide a display device, data driving circuit, and display panel driving method capable of displaying high-quality images.

A display device according to an aspect of the present invention comprises, a plurality of selection scan lines;
a plurality of current lines;
a selection scan driver which sequentially selects the plurality of selection scan lines in each selection period;
a data driving circuit which applies a reset voltage to the plurality of current lines in a first part of the selection period, and supplies a designating current having a current value corresponding to an image signal to the plurality of current lines in a second part of the selection period after applying the reset voltage in the selection period; and
a plurality of pixel circuits which are connected to the plurality of selection scan lines and the plurality of current lines, and supply a driving current having a current value corresponding to the current value of the designating current which flows through the plurality of current lines.

A display device according to another aspect of the present invention comprises, a plurality of selection scan lines;
a plurality of current lines;
a plurality of light-emitting elements which are arranged at intersections of the plurality of selection scan lines and the plurality of current lines, and emit light at luminance corresponding to a current value of a driving current;
a selection scan driver which sequentially select the plurality of selection scan lines in each selection period;
a data driving circuit which applies a reset voltage to the plurality of current lines in a first part of the selection period, and supplies a designating current having a current value corresponding to an image signal to the plurality of current lines in a second part of the selection period after applying the reset voltage in the selection period; and
a plurality of pixel circuits which are connected to the plurality of selection scan lines and the plurality of current lines, and electrically connect the plurality of current lines and the plurality of light-emitting elements to each other in the selection period.

A data driving circuit according to still another aspect of the present invention comprises, a plurality of light-emitting elements connected to a plurality of selection scan lines and a plurality of current lines, a selection scan driver which sequentially selects the plurality of selection scan lines in each selection period, and a plurality of pixel circuits connected to the plurality of light-emitting elements,
wherein a reset voltage is applied to the plurality of current lines in a first part of the selection period, and a designating current having a current value corresponding to an image signal is supplied to the plurality of current lines in a second part of the selection period after the first part of the selection period.

A display panel driving method according to still another aspect of the present invention comprises, a selection step of sequentially selecting a plurality of selection scan lines of a display panel comprising a plurality of pixel circuits connected to the plurality of selection scan lines and a plurality of current lines, and a plurality of light-emitting elements which are arranged at intersections of the plurality of selection scan lines and the plurality of current lines, each of the light-emitting elements emits light at luminance corresponding to a current value of a current flowing the current line; and
a reset step of applying a reset voltage to the plurality of current lines in an initial part of a period in which each of the plurality of selection scan lines is selected.

In the present invention, it is possible not only to discharge the parasitic capacitance of a current line by applying a reset voltage in a selection period, but also to discharge the parasitic capacitance of a pixel circuit or the parasitic capacitance of a light-emitting element.

### BRIEF DESCRIPTION OF THE SEVERAL VIEWS OF THE DRAWING

FIG. 1 is a block diagram of an organic electroluminescent display 1 according to the first embodiment of the present invention;

FIG. 2 is a plan view of a pixel P_{i,j} of the organic electroluminescent display 1;

FIG. 3 is an equivalent circuit diagram of four adjacent pixels P_{i,j}, P_{i+1,j}, P_{i,j+1} and P_{i+1,j+1} of the organic electroluminescent display 1;

FIG. 4 is a timing chart showing the levels of signals in the organic electroluminescent display 1;

FIG. 5 is a graph showing the current-voltage characteristics of an N-channel field-effect transistor;

FIG. 6 shows an equivalent circuit diagram of two adjacent pixels P_{i,j and P}_{i,j+1} in the ith row, and the states of electric currents and voltages in a reset period T_{R} of the ith row;

FIG. 7 shows the equivalent circuit diagram of the two adjacent pixels P_{i,j} and P_{i,j+1} in the ith row, and the states of electric currents and voltages after the reset period T_{R} in a selection period T_{SE} of the ith row;

FIG. 8 shows the equivalent circuit diagrams of the two adjacent pixels P_{i,j} and P_{i,j+1} in the ith row, and the states of electric currents and voltages in a non-selection period T_{NSE} of the ith row;

FIG. 9 is a timing chart showing the levels of electric currents and voltages pertaining to the pixel P_{i,j};

FIG. 10 is a block diagram of an organic electroluminescent display according to the second embodiment of the present invention;

FIG. 11 is a block diagram of an organic electroluminescent display according to the third embodiment of the present invention; and

FIG. 12 is a block diagram of an organic electroluminescent display according to the fourth embodiment of the present invention.

### DETAILED DESCRIPTION OF THE INVENTION

Best modes for carrying out the invention will be described below with reference to the accompanying drawings. Various technically preferred limitations are imposed on the following embodiments in order to, carry out the present invention. However, the scope of the invention is not limited to the embodiments and examples shown in the drawing.

### First Embodiment

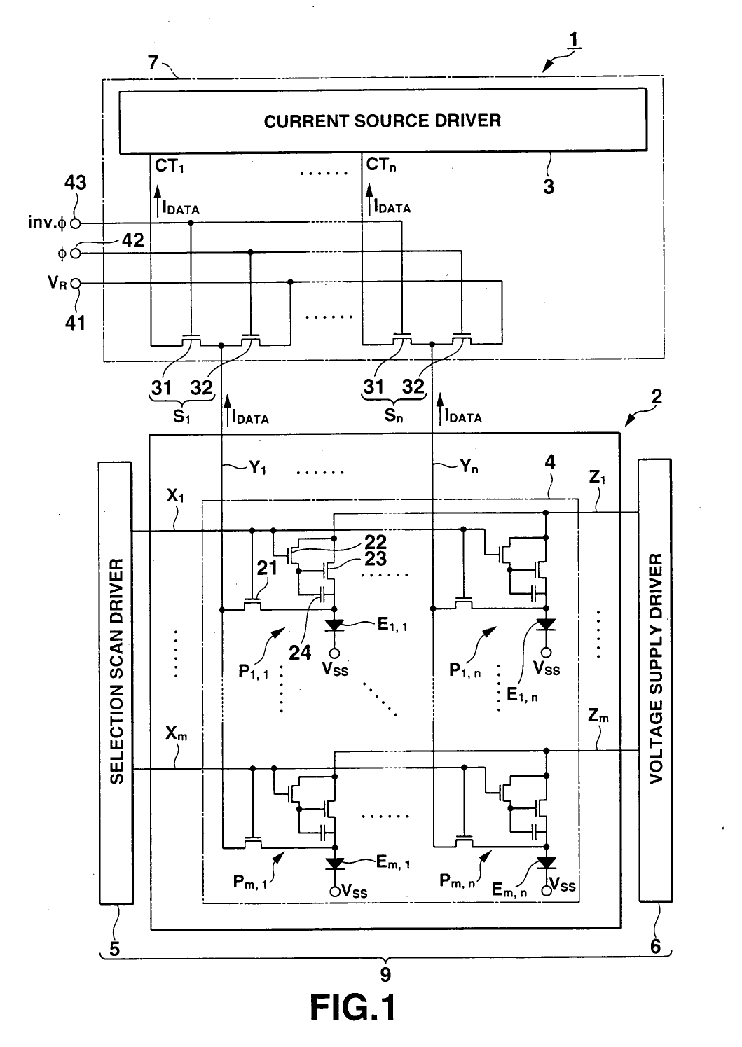

FIG. 1 is a block diagram showing an organic electroluminescent display 1 according to the first embodiment to which the organic electroluminescent display of the present invention is applied. As shown in FIG. 1, the organic electroluminescent display 1 includes, as its basic configuration, an organic electroluminescent display panel 2 having m selection scan lines X₁ to Xₘ, m voltage supply lines Z₁ to Zₘ, n current lines Y₁ to Yₙ, and pixels P_{1,1} to P_{m,n}. The display 1 further includes, a scan driving circuit 9 for linearly scanning the organic electroluminescent display panel 2 in the longitudinal direction, and a data driving circuit 7 for supplying a tone designating current I_{DATA} to the current lines Y₁ to Yₙ in cooperation with the scan driving circuit 9. Here, each of m and n is a natural number of 2 or more.

The can driving circuit 9 has a selection scan driver 5 for sequentially selecting the selection scan lines X₁ to Xₘ, and a voltage supply driver 6 for sequentially selecting the voltage supply lines Z₁ to Zₙ in synchronism with the sequential selection of the selection scan lines X₁ to Xₘ by the selection scan driver 5. The data driving circuit 7 has a current source driver 3. The driver 3 includes n current terminals CT₁ to CTₙ and allows the tone designating current I_{DATA} to flow through the current terminals CT₁ to CTₙ, and switches S₁ to Sₙ interposed between the current terminals CT₁ to CTₙ and current lines Y₁ to Yₙ.

The organic electroluminescent display panel 2 has a structure in which a display unit 4 for practically displaying images is formed on a transparent substrate. The selection scan driver 5, voltage supply driver 6, current source driver 3, and switches S₁ to Sₙ are arranged around the display unit 4. Portions or the whole of the selection scan driver 5, the voltage supply driver 6, the current source driver 3, and at least one of the switches S₁ to Sₙ can be integrated with the organic electroluminescent display panel 2 as they are formed on the transparent substrate, or can be formed around the organic electroluminescent display panel 2 as they are formed into a chip different from the organic electroluminescent display panel 2. Note that the display unit 4 may also be formed on a flexible sheet such as a resin sheet, instead of the transparent substrate.

In the display unit 4, the (m×n) pixels P_{1,1} to P_{m,n} are formed in a matrix on the transparent substrate such that m pixels are arranged in the longitudinal direction, i.e., the column direction, and n pixels are arranged in the lateral direction, i.e., the row direction. A pixel which is an ith pixel (i.e., a pixel in the ith row) from above and a jth pixel (i.e., a pixel in the jth column) from left is a pixel P_{i,j}. Note that i is a given natural number from 1 to m, and j is a given natural number from 1 to n.

Accordingly, in the display unit 4, the m selection scan lines X₁ to Xₘ running in the row direction are formed parallel to each other on the transparent substrate. The m voltage supply lines Z₁ to Zₘ running in the row direction are formed parallel to each other on the transparent substrate in one-to-one correspondence with the selection scan lines X₁ to Xₘ. The voltage supply line Zₖ (1≦k≦m−1) is positioned between the selection scan lines Xₖ and Xₖ₊₁, and the selection scan line Xₘ is positioned between the voltage supply lines Zₘ₋₁ and Zₘ. Also, the n current lines Y₁ to Yₙ running in the column direction are formed parallel to each other on the upper side of the transparent substrate. The selection scan lines X₁ to Xₘ, voltage supply lines Z₁ to Zₘ, and current lines Y₁ to Yₙ are insulated from each other as they are separated by insulating films or the like interposed between them. The n pixels P_{i,1} to P_{i,n} arranged along the row direction are connected to the selection scan line Xᵢ and voltage supply line Zᵢ in the ith row. The m pixels P_{1,j} to P_{m,j} arranged along the column direction are connected to the current line Yⱼ in the jth column. The pixel P_{i,j} is positioned at the intersection of the selection scan line Xᵢ and current line Yⱼ. The selection scan lines X₁ to Xₘ are connected to output terminals of the selection scan driver 5. The voltage supply lines Z₁ to Zₘ are connected to output terminals of the voltage supply driver 6.

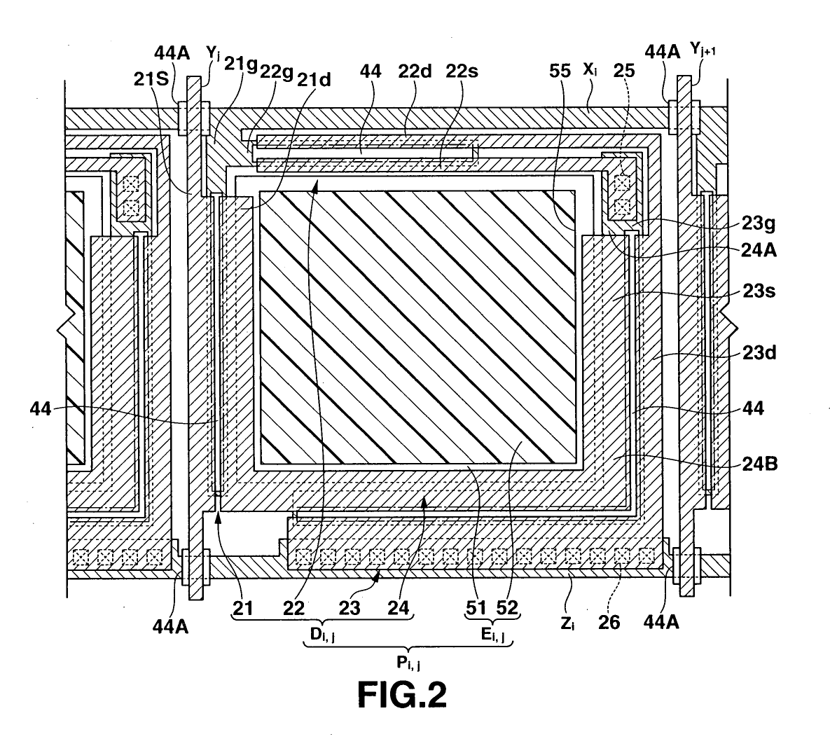

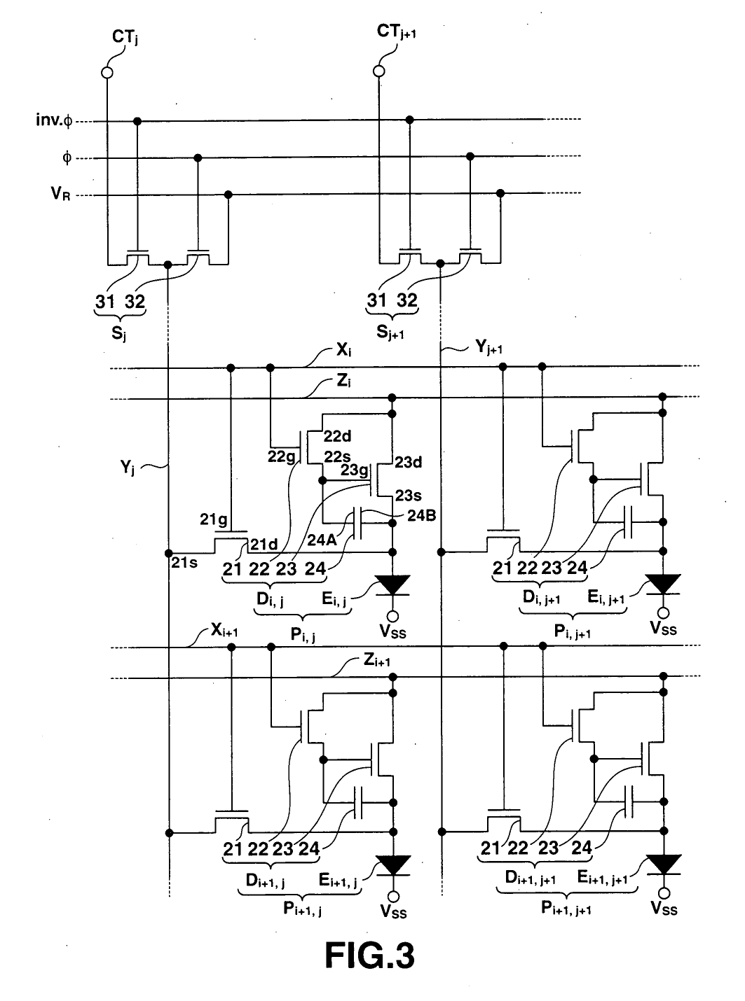

The pixels P_{1,1} to P_{m,n} will be explained below with reference to FIGS. 2 and 3. FIG. 2 is a plan view showing the pixel P_{i,j}. FIG. 3 is an equivalent circuit diagram showing, e.g., four adjacent pixels P_{i,j}, P_{i+1,j}, P_{i,j+1}, and P_{i+1,j+1}. FIG. 2 principally shows the electrodes in the pixel P_{i,j} to allow better understanding.

The pixel P_{i,j} includes an organic electroluminescent element E_{i,j} as a self-light-emitting element which emits light in accordance with the value of an electric current, and a pixel circuit D_{i,j} which is formed around the organic electroluminescent element E_{i,j}, and drives it. Note that the organic electroluminescent element will be referred to as an organic EL element hereinafter.

The organic EL element E_{i,j} has a stacked structure in which a pixel electrode 51, organic EL layer 52, and common electrode are stacked in this order on the transparent substrate. The pixel electrode 51 functions as an anode. The organic EL layer 52 functions as a light-emitting layer in a broad sense, i.e., transports holes and electrons injected by an electric field, recombines the transported holes and electrons, and emits light by excitons produced by the recombination. The common electrode functions as a cathode. Although the common electrode is formed to cover the entire pixel, the it is not shown in FIG. 2 so that the pixel electrode 51, organic EL layer 52, pixel circuit D_{i,j} and the like are readily seen.

The pixel electrode 51 is patterned for each of the pixels P_{1,1} to P_{m,n} in each of regions surrounded by the current lines Y₁ to Yₙ, selection scan lines X₁ to Xₘ, and voltage supply lines Z₁ to Zₘ.

The pixel electrode 51 is a transparent electrode. That is, the pixel electrode 51 has both conductivity and transparency to visible light. Also, the pixel electrode 51 preferably has a relatively high work function, and efficiently injects holes into the organic EL layer 52. Examples of main components of the pixel electrode 51 are tin-doped indium oxide (ITO), zinc-doped indium oxide, indium oxide (In₂O₃), tin oxide (SnO₂), zinc oxide (ZnO), and cadmium-tin oxide (CTO).

The organic EL layer 52 is formed on each pixel electrode 51. The organic EL layer 52 is also patterned for each of the pixels P_{1,1} to P_{m,n}. The organic EL layer 52 contains a light-emitting material (phosphor) as an organic compound. This light-emitting material can be either a high- or low-molecular material. In particular, the organic EL layer 52 has a two-layered structure in which a hole transporting layer and a light-emitting layer in a narrow sense are stacked in this order on the pixel electrode 51. The hole transporting layer is made of a PEDOT (polythiophene) as a conductive polymer, and PSS (polystyrene sulfonic acid) as a dopant. The light-emitting layer in a narrow sense is made of a polyfluorene-based, light-emitting material. Note that the organic EL layer 52 may also have a three-layered structure having a hole transporting layer, a light-emitting layer in a narrow sense, and an electron transporting layer stacked in this order on the pixel electrode 51, or a single-layered structure having only a light-emitting layer in a narrow sense, instead of the two-layered structure. An electron or hole injecting layer may also be interposed between appropriate layers in any of these layered structures, and some other stacked structure may also be used.

The organic EL display panel 2 can display full-color images or multicolor images. The organic EL layer 52 of each of the pixels P_{1,1} to P_{m,n} is a light-emitting layer in a broad sense which has a function of emitting red, green, or blue light. That is, the organic EL layers 52 which emit red light, green light, and blue light are regularly arranged, and the display unit 4 displays images in a color tone obtained by properly synthesizing these colors.

The organic EL layer 52 is desirably made of an organic compound which is neutral with respect of electrons. This allows balanced injection and transportation of holes and electrons in the organic EL layer 52. One or both of an electron transporting substance and hole transporting substance may also be properly mixed in the light-emitting layer in a narrow sense. It is also possible to cause a charge transporting layer which is an electron or hole transporting layer to function as a recombination region which recombines electrons and holes, and to emit light by mixing a phosphor in this charge transporting layer.

The common electrode formed on the organic EL layers 52 is formed for all the pixels P_{1,1} to P_{m,n}. Note that instead of this common electrode formed for all the pixels P_{1,1} to P_{m,n}, it is also possible to use a plurality of divided electrodes, e.g., a plurality of stripe electrodes divided for individual columns, or a plurality of stripe electrodes divided for individual rows. Generally, the organic EL layers 52 which emit different colors are made of different materials, and the light emission characteristics with respect to the current density depend upon the material. To adjust the luminance balance between different emission colors, therefore, pixels which emit the same color can be connected together in order to set the value of an electric current for each emission color of the organic EL layer 52. That is, assuming that a first-emission-color pixel emits a predetermined luminance at a relatively low current density, and a second-emission-color pixel requires a high current density in order to emit the same luminance as the first-emission-color pixel, the emission color balance can be adjusted by supplying, to the second-emission-color pixel, a tone electric current which is larger than that of the first-emission-color pixel.

The common electrode is electrically insulated from the selection scan lines X₁ to Xₘ, current lines Y₁ to Yₙ, and voltage supply lines Z₁ to Zₘ. The common electrode is made of a material having a low work function. For example, the common electrode is made of indium, magnesium, calcium, lithium, barium, a rare earth metal, or an alloy containing at least one of these elements. Also, the common electrode can have a stacked structure in which layers of the various materials described above are stacked, or a stacked structure in which a metal layer is deposited in addition to these layers of the various materials. Practical examples are a stacked structure including a low-work-function, high-purity barium layer formed in the interface in contact with the organic EL layer 52, and an aluminum layer which covers this barium layer, and a stacked structure having a lithium layer as a lower layer and an aluminum layer as an upper layer. When the pixel electrode 51 is a transparent electrode and light emitted from the organic EL layer 52 is output from the transparent substrate through the pixel electrode 51, the common electrode preferably has light-shielding properties with respect to the light emitted from the organic EL layer 52, and more preferably has a high reflectance to the light emitted from the organic EL layer 52.

When a forward bias voltage (by which the voltage of the pixel electrode 51 becomes higher than that of the common electrode) is applied between the pixel electrode 51 and common electrode in the organic EL element E_{i,j} having the stacked structure as described above, holes are injected into the organic EL layer 52 from the pixel electrode 51, and electrons are injected into the organic EL layer 52 from the common electrode. The organic EL layer 52 transports these holes and electrons, and recombines them to produce excitons. Since these excitons excite the organic EL layer 52, the organic EL layer 52 emits light.

The luminance of the organic EL element E_{i,j} depends on the current value of an electric current which flows through the organic EL element E_{i,j}; the larger the electric current which flows through the organic EL element E_{i,j}, the higher the luminance of the organic EL element E_{i,j}. That is, if deterioration of the organic EL element E_{i,j} is not taken into consideration, the luminance of the organic EL element E_{i,j} is uniquely determined when the current value of the electric current which flows through the organic EL element E_{i,j} is determined.

Each of the pixel circuits D_{1,1} to D_{m,n} includes three thin-film transistors (to be simply referred to as transistors hereinafter) 21, 22, and 23, and a capacitor 24.

Each of the transistors 21, 22, and 23 is an N-channel MOS field-effect transistor having a gate, drain, source, semiconductor layer 44, impurity-dosed semiconductor layer, and gate insulating film. Each transistor is particularly an a-Si transistor in which the semiconductor layer 44 (channel region) is made of amorphous silicon. However, each transistor may also be a p-Si transistor in which the semiconductor layer 44 is made of polysilicon. In either case, the transistors 21, 22, and 23 are N-channel field-effect transistors, and can have either an inverted stagger structure or a coplanar structure.

Also, the transistors 21, 22, and 23 can be simultaneously formed in the same process. In this case, the compositions of the gates, drains, sources, semiconductor layers 44, impurity-dosed semiconductor layers, and gate insulating films of the transistors 21, 22, and 23 are the same, and the shapes, sizes, dimensions, channel widths, and channel lengths of the transistors 21, 22, and 23 are different from each other in accordance with the functions of the transistors 21, 22, and 23. Note that the transistors 21, 22, and 23 will be referred to as a first transistor 21, second transistor 22, and driving transistor 23, respectively, hereinafter.

The capacitor 24 has a first electrode 24A connected to a gate 23g of the driving transistor 23, a second electrode 24B connected to a source 23s of the transistor 23, and a gate insulating film (dielectric film) interposed between these two electrodes. The capacitor 24 has a function of storing electric charges between the gate 23g and source 23s of the driving transistor 23.

In the second transistor 22 of each of the pixel circuits D_{i,1} to D_{i,n} in the ith row, a gate 22g is connected to the selection scan line Xᵢ in the ith row, and a drain 22d is connected to the voltage supply line Zᵢ in the ith row. In the driving transistor 23 of each of the pixel circuits D_{i,1} to D_{i,n} in the ith row, a drain 23d is connected to the voltage supply line Zᵢ in the ith row through a contact hole 26. In the first transistor 21 of each of the pixel circuits D_{i,1} to D_{i,n} in the ith row, a gate 21g is connected to the selection scan line Xᵢ in the ith row. In the first transistor 21 of each of the pixel circuits D_{1,j} to D_{m,j} in the jth column, a source 21s is connected to the current line Yⱼ in the jth column.

In each of the pixels P_{1,1} to P_{m,n}, a source 22s of the second transistor 22 is connected to the gate 23g of the driving transistor 23 through a contact hole 25, and to one electrode of the capacitor 24. The source 23s of the driving transistor 23 is connected to the other electrode of the capacitor 24, and to a drain 21d of the first transistor 21. The source 23s of the driving transistor 23, the other electrode of the capacitor 24, and the drain 21d of the first transistor 21 are connected to the pixel electrode 51.

The voltage of the common electrode of the organic EL elements E_{1,1}, to E_{m,n} is held at a predetermined reference voltage V_{SS}. In this embodiment, the reference voltage V_{SS} is set at 0 [V] by grounding the common electrode of the organic EL elements E_{1,1}, to E_{m,n}.

The pixel electrodes 51 are divided by patterning for individual pixels surrounded by regions surrounded by the current lines Y₁ to Yₙ, selection scan lines X₁ to Xₘ, and voltage supply lines Z₁ to Zₘ. In addition, the edges of each pixel electrode 51 are covered with an interlayer dielectric film made of silicon nitride or silicon oxide which covers the three transistors 21, 22, and 23 of each pixel circuit, and the upper surface of the center of the pixel electrode 51 is exposed through a contact hole 55 formed in this interlayer dielectric film. Note that the interlayer dielectric film can have a first layer made of silicon nitride or silicon oxide, and a second layer formed on the first layer by using an insulating film made of, e.g., polyimide.

Between the selection scan line Xᵢ and current line Yⱼ, and between the voltage supply line Zᵢ and current line Yⱼ, a protective film 44A is formed by patterning the same film as the semiconductor layer 44 of each of the transistors 21 to 23, in addition to the gate insulating film. Note that in order to protect the surface, which serves as a channel, of the semiconductor layer 44 of each of the transistors 21, 22, and 23 from being roughened by an etchant used in patterning, a blocking insulating layer made of silicon nitride or the like may also be formed except for the two end portions of the semiconductor layer 44. In this case, a protective film may be formed by patterning the same film as the blocking insulating layer between the selection scan line Xᵢ and current line Yⱼ, and between the voltage supply line Zᵢ and current line Yⱼ. This protective film and the protective film 44A may also be overlapped.

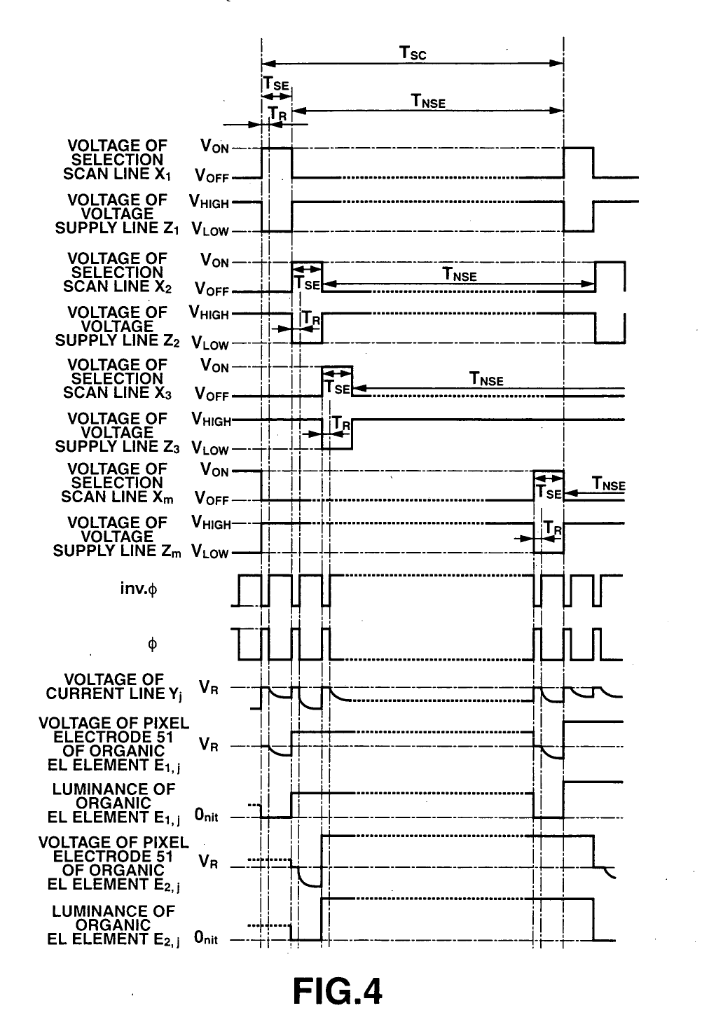

The selection scan driver 5, voltage supply driver 6, switches S₁ to Sₙ, and current source driver 3 will be described below with reference to FIG. 4. FIG. 4 is a timing chart showing, from above, the voltage of the selection scan line X₁, the voltage of the voltage supply line Z₁, the voltage of the selection scan line X₂, the voltage of the voltage supply line Z₂, the voltage of the selection scan line X₃, the voltage of the voltage supply line Z₃, the voltage of the selection scan line Xₘ, the voltage of the voltage supply line Zₘ, the level (voltage value) of a switching signal inv.Φ, the level of a switching signal Φ, the voltage of the current line Yⱼ, the voltage of the pixel electrode 51 of the organic EL element E_{1,j}, the luminance of the organic EL element E_{1,j}, the voltage of the pixel electrode 51 of the organic EL element E_{2,j}, and the luminance of the organic EL element E_{2,j}. Referring to FIG. 4, the abscissa represents the common time.

The selection scan driver 5 is a so-called shift register, and has an arrangement in which m flip-flop circuits and the like are connected in series. That is, the selection scan driver 5 sequentially selects the selection scan lines X₁ to Xₘ by sequentially outputting selection signals in order from the selection scan line X₁ to the selection scan line Xₘ (the selection scan line Xₘ is followed by the selection scan line X₁), thereby sequentially selecting the first and second transistors 21 and 22 in these rows connected to the selection scan lines X₁ to Xₘ.

More specifically, as shown in FIG. 4, the selection scan driver 5 individually applies, to the selection scan lines X₁ to Xₘ, a high-level (ON-level) ON voltage V_{ON} (much higher than the reference voltage V_{SS}) as a selection signal or a low-level OFF voltage V_{OFF} (equal to or lower than the reference voltage V_{SS}) as a non-selection signal, thereby sequentially selecting the selection scan lines X₁ to Xₘ.

That is, when the selection scan driver 5 applies the ON voltage V_{ON} to the selection scan line Xᵢ, the selection scan line Xᵢ in the ith row is selected. A period in which the selection scan driver 5 applies the ON voltage V_{ON} to the selection scan line Xᵢ in the ith row and thereby selects the selection scan line Xᵢ in the ith row is called a selection period T_{SE} of the ith row. Note that while applying the ON voltage V_{ON} to the selection scan line Xᵢ, the selection scan driver 5 applies the OFF voltage V_{OFF} to the other selection scan lines X₁ to Xₘ (except for the selection scan line Xᵢ). Accordingly, the selection periods T_{SE} of the selection scan lines X₁ to Xₘ do not overlap each other.

When the selection scan driver 5 applies the ON voltage V_{ON} to the selection scan line Xᵢ in the ith row, the first and second transistors 21 and 22 are turned on in each of the pixel circuits D_{i,1} to D_{i,n} connected to the selection scan line Xᵢ in the ith row. Since the first transistors 21 are turned on, an electric current which flows through the current lines Y₁ to Yₙ can flow through the pixel circuits D_{i,1} to D_{i,n}.

After the selection period T_{SE} in which the selection scan line Xᵢ in the ith row is selected, the selection scan driver 5 applies the OFF voltage V_{OFF} to the selection scan line Xᵢ to cancel the selection of the selection scan line Xᵢ. As a consequence, in each of the pixel circuits D_{i,1} to D_{i,n} connected to the selection scan line Xᵢ in the ith row, the first and second transistors 21 and 22 are turned off. Since the first transistors 21 are turned off, the electric current which flows through the current lines Y₁ to Yₙ cannot flow through the pixel circuits D_{i,1} to D_{i,n} any longer. Note that a period in which the selection scan driver 5 applies the OFF voltage V_{OFF} to the selection scan line Xᵢ in the ith row and thereby keeps the selection scan line Xᵢ in the ith row unselected is called a non-selection period T_{NSE} of the ith row. In this case, a period represented by T_{SE}+T_{NSE}=T_{SC}, i.e., a period from the start time of the selection period T_{SE} of the selection scan line Xᵢ in the ith row to the start time of the next selection period T_{SE} of the selection scan line Xᵢ in the ith row, is one frame period of the ith row.

The voltage supply driver 6 is a so-called shift register, and has an arrangement in which m flip-flop circuits are connected in series. That is, in synchronism with the selection scan driver 5, the voltage supply driver 6 sequentially selects the voltage supply lines Z₁ to Zₘ by sequentially outputting selection signals in order from the voltage supply line Z₁ to the voltage supply line Zₘ (the voltage supply line Zₘ is followed by the voltage supply line Z₁), thereby sequentially selecting the driving transistors 23 in these rows connected to the voltage supply lines Z₁ to Zₘ.

More specifically, as shown in FIG. 4, the voltage supply driver 6 individually supplies, to the voltage supply lines Z₁ to Zₘ, a low-level tone designating current reference voltage V_{LOW} (which is equal to or lower than the reference voltage V_{SS}) as a selection signal or a high-level driving current reference voltage V_{HIGH} (which is higher than both the reference voltage V_{SS} and tone designating current reference voltage V_{LOW}) as a non-selection signal, thereby sequentially selecting the voltage supply lines Z₁ to Zₘ.

That is, in the selection period T_{SE} in which the selection scan line Xᵢ in the ith row is selected, the voltage supply driver 6 applies the tone designating current reference voltage V_{LOW} to the voltage supply line Zᵢ in the ith row, thereby selecting the voltage supply line Zᵢ in the ith row. While applying the tone designating current reference voltage V_{LOW} to the voltage supply line Zᵢ, the voltage supply driver 6 applies the driving current reference voltage V_{HIGH} to the other voltage supply lines Z₁ to Zₘ (except for the voltage supply line Zᵢ).

On the other hand, in the non-selection period T_{NSE} in which the selection scan line Xᵢ in the ith row is not selected, the voltage supply driver 6 applies the driving current reference voltage V_{HIGH} to the voltage supply line Zᵢ to cancel the selection of the voltage supply line Zᵢ in the ith row. Since the driving current reference voltage V_{HIGH} is higher than the reference voltage V_{SS}, an electric current flows from the voltage supply line Zᵢ to the organic EL element E_{i,j} if the driving transistor 23 is ON and the transistor 21 is OFF.

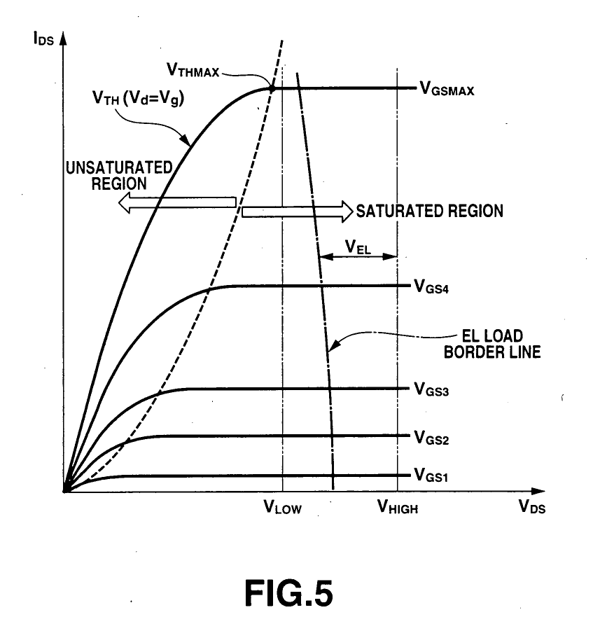

The tone designating current reference voltage V_{LOW} applied by the voltage supply driver 6 is equal to or lower than the reference voltage V_{SS}. Therefore, even when the driving transistor 23 of each of the pixels P_{1,1} to P_{m,n} is turned on in the selection period T_{SE}, a zero voltage or reverse bias voltage is applied between the anode and cathode of each of the organic EL elements E_{1,1} to E_{m,n}. Accordingly, no electric current flows through the organic EL elements E_{1,1} to E_{m,n} in the selection period T_{SE}, so the organic EL elements E_{1,1} to E_{m,n} do not emit light. On the other hand, the driving current reference voltage V_{HIGH} applied by the voltage supply driver 6 is higher than the reference voltage V_{SS}. As shown in FIG. 5, the driving current reference voltage V_{HIGH} is so set that a source-to-drain voltage V_{DS} of the driving transistor 23 is in a saturated region. Accordingly, when the driving transistors 23 are ON in the non-selection period T_{NSE}, a forward bias voltage is applied to the organic EL elements E_{1,1}, to E_{m,n}. In the non-selection period T_{NSE}, therefore, an electric current flows through the organic EL elements E_{1,1} to E_{m,n}, and the organic EL elements E_{1,1} to E_{m,n} emit light.

The driving current reference voltage V_{HIGH} will be explained below. FIG. 5 is a graph showing the current-voltage characteristics of the N-channel field-effect transistor. Referring to FIG. 5, the abscissa indicates the divided voltage of the driving transistor and the divided voltage of the organic EL element connected in series to the driving transistor, and the ordinate indicates the current value of an electric current in the drain-to-source path. In an unsaturated region (a region where source-to-drain voltage V_{DS}<drain saturated threshold voltage V_{TH}: the drain saturated threshold voltage V_{TH} is a function of a gate-to-source voltage V_{GS}, and is uniquely determined by the gate-to-source voltage V_{GS} if the gate-to-source voltage V_{GS} is determined) shown in FIG. 5, if the gate-to-source voltage V_{GS} is constant, a drain-to-source current I_{DS} increases as the source-to-drain voltage V_{DS} increases. In addition, in a saturated region (in which source-to-drain voltage V_{DS}≧drain saturated threshold voltage V_{TH}) shown in FIG. 5, if the gate-to-source voltage V_{GS} is constant, the drain-to-source current I_{DS} is substantially constant even when the source-to-drain voltage V_{DS} increases.

Also, in FIG. 5, gate-to-source voltages V_{GS1} to V_{GSMAX} have the relationship 0 [V]<V_{GS1}<V_{GS2}<V_{GS3}<V_{GS4}<V_{GSMAX}. That is, as is apparent from FIG. 5, if the source-to-drain voltage V_{DS} is constant, the drain-to-source current I_{DS} increases in both the unsaturated and saturated regions as the gate-to-source voltage V_{GS} increases. In addition, the drain saturated threshold voltage V_{TH} increases as the gate-to-source voltage V_{GS} increases.

From the foregoing, in the unsaturated region, the drain-to-source current I_{DS} changes if the source-to-drain voltage V_{DS} slightly changes while the gate-to-source voltage V_{GS} is constant. In the saturated region, however, the drain-to-source current I_{DS} is uniquely determined by the gate-to-source voltage V_{GS}.

The drain-to-source current I_{DS} when the maximum gate-to-source voltage V_{GSMAX} is applied to the driving transistor 23 is set to be an electric current which flows between the common electrode and the pixel electrode 51 of the organic EL element E_{i,j} which emits light at the maximum luminance.

Also, the following equation is met so that the driving transistor 23 maintains the saturated region in the selection period T_{SE} even when the gate-to-source voltage V_{GS} of the driving transistor 23 is the maximum voltage V_{GSMAX} in the non-selection period.
V_{LOW}=V_{HIGH}−V_{E}−V_{SS}−V_{THMAX}
where V_{E} is the anode-to-cathode voltage which the organic EL element E_{i,j} requires to emit light at the maximum luminance in the light emission life period, and V_{THMAX} is the source-to-drain saturated voltage level of the driving transistor 23 when the voltage is V_{GSMAX}. The driving current reference voltage V_{HIGH} is set to satisfy the above equation. Accordingly, even when the source-to-drain voltage V_{DS} of the driving transistor 23 decreases by the divided voltage of the organic EL element E_{i,j} connected in series to the driving transistor 23, the source-to-drain voltage V_{DS} always falls within the range of the saturated state, so the drain-to-source current I_{DS} is uniquely determined by the gate-to-source voltage V_{GS}.

As shown in FIGS. 1 and 3, the current lines Y₁ to Yₙ are connected to the current terminals CT₁ to CTₙ of the current source driver 3 via the switches S₁ to Sₙ. An 8-bit digital tone image signal is input to the current source driver 3. This digital tone image signal input to the current source driver 3 is converted into an analog signal by an internal D/A converter of the current source driver 3. The current source driver 3 generates, at the current terminals CT₁ to CTₙ, a tone designating current I_{DATA} having a current value corresponding to the converted analog signal. As shown in FIG. 4, the current source driver 3 controls the current value of the tone designating current I_{DATA} at the current terminals CT₁ to CTₙ in accordance with the image signal for each selection period T_{SE} of each row, and holds the current value of the tone designating current I_{DATA} constant in a period from the end of each reset period T_{R} to the end of the corresponding selection period T_{SE}. The current source driver 3 supplies the tone designating current I_{DATA} from the current lines Y₁ to Yₙ to the current terminals CT₁ to CTₙ via the switches S₁ to Sₙ. As shown in FIGS. 1 and 3, the switches S₁ to Sₙ are connected to the current lines Y₁ to Yₙ, and the current terminals CT₁ to CTₙ of the current source driver 3 are connected to the switches S₁ to Sₙ. In addition, the switches S₁ to Sₙ are connected to a reset input terminal 41, and a reset voltage V_{R} is applied to the switches S₁ to Sₙ via the reset input terminal 41. The switches S₁ to Sₙ are also connected to a switching signal input terminal 42, and a switching signal Φ is input to the switches S₁ to Sₙ via the switching signal input terminal 42. Furthermore, the switches S₁ to Sₙ are connected to a switching signal input terminal 43, and a switching signal inv.Φ obtained by inverting the switching signal Φ is input to the switches S₁ to Sₙ via the switching signal input terminal 43. The reset voltage V_{R} is constant and has the same level (voltage value) as the tone designating current reference voltage V_{LOW}. More specifically, the reset voltage V_{R} is set at 0 [V] by grounding the reset input terminal 41. Especially when the reset voltage V_{R} of the ith row is made equal to the voltage of the voltage supply line Zᵢ in the ith row in the selection period T_{SE}, the voltages of the electrodes 24A and 24B of the capacitor 24 become equal to each other. Consequently, the capacitor 24 is discharged, so the gate-to-source voltage of the driving transistor 23 is set at 0V.

The switch Sⱼ (which is interposed between the current line Yⱼ in the jth column and the current terminal CTⱼ in the jth column) switches the state in which the current source driver 3 supplies the tone designating current I_{DATA} to the current line Yⱼ, and the state in which the reset voltage V_{R} is applied to the current line Yⱼ. That is, as shown in FIG. 4, if the switching signal Φ is at high level and the switching signal inv.Φ is at low level, the switch Sⱼ shuts off the electric current of the current terminal CTⱼ, and applies the reset voltage V_{R} to the current line Yⱼ, the drain 21d of the first transistor 21, the electrode 24B of the capacitor 24, the source 23s of the driving transistor 23, and the pixel electrode 51 of the organic EL element E_{x,j} (1≦x≦m), thereby discharging the electric charge stored in these components in the preceding selection period T_{SE}. On the other hand, if the switching signal Φ is at low level and the switching signal inv.Φ is at high level, the switch Sⱼ allows the electric current of the current terminal CTⱼ to flow through the current line Yⱼ, and shuts down the application of the reset voltage V_{R} to the current line Yⱼ.

The cycle of the switching signals Φ and inv.Φ will be explained below. As shown in FIG. 4, the cycle of the switching signals Φ and inv.Φ is the same as the selection period T_{SE}. That is, when the selection scan driver 5 starts applying the ON voltage VON to one of the selection scan lines X₁ to Xₘ (i.e., when the selection period T_{SE} of each row starts), the switching signal Φ changes from high level to low level, and the switching signal inv.Φ changes from low level to high level. While the selection scan driver 5 is applying the ON voltage V_{ON} to one of the selection scan lines X₁ to Xₘ (i.e., in the selection period T_{SE} of each row), the switching signal Φ changes from low level to high level, and the switching signal inv.Φ changes from high level to low level. A period in which the switching signal Φ is at high level and the switching signal inv.Φ is at low level in the selection period T_{SE} of the selection scan line Xᵢ in the ith row is called the reset period T_{R} of the ith row.

An example of the switch Sⱼ will be explained below. The switch Sⱼ is made up of first and second N-channel field-effect transistors 31 and 32. The gate of the first transistor 31 is connected to the switching signal input terminal 43, and thus the switching signal inv.Φ is input to the gate of the transistor 31. Also, the gate of the second transistor 32 is connected to the switching signal input terminal 42, and thus the switching signal Φ is input to the gate of the transistor 32. The drain of the first transistor 31 is connected to the current line Yⱼ, and the source of the transistor 31 is connected to the current terminal CTⱼ. The drain of the transistor 32 is connected to the current line Yⱼ. The source of the transistor 32 is connected to the reset input terminal 41, and the reset voltage V_{R} which is a constant voltage is applied to the source of the transistor 32. In this arrangement, when the switching signal Φ is at high level and the switching signal inv.Φ is at low level, the transistor 32 is turned on, and the transistor 31 is turned off. When the switching signal Φ is at low level and the switching signal inv.Φ is at high level, the transistor 31 is turned on, and the transistor 32 is turned off. The transistors 31 and 32 can be fabricated in the same steps as the transistors 21 to 23 of the pixel circuits D_{1,1} to D_{m,n}.

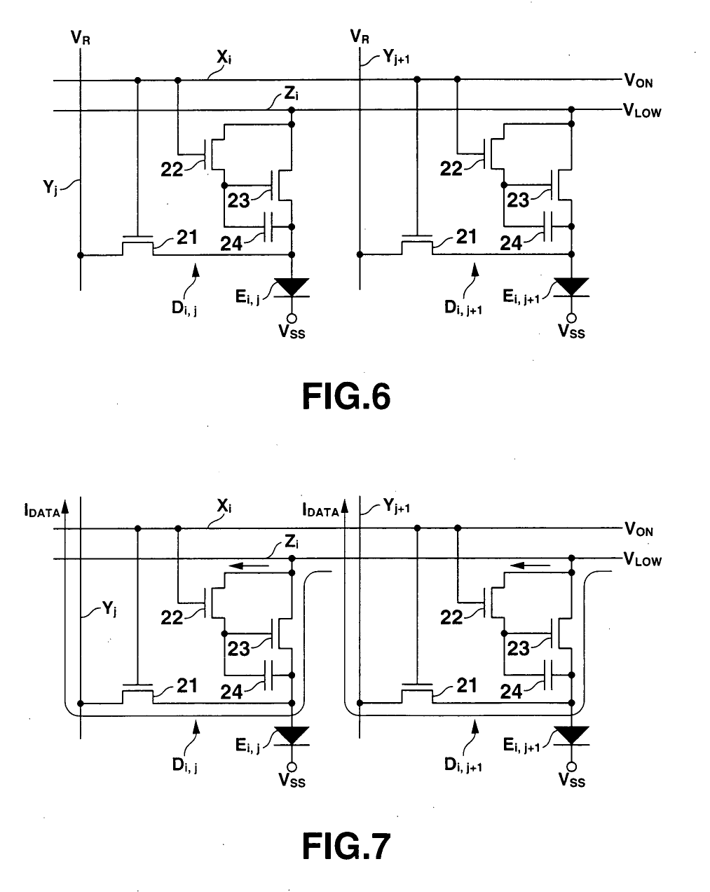

The functions of the pixel circuits D_{1,1} to D_{m,n} will be described below with reference to FIGS. 6 to 8. In FIGS. 6 to 8, the flows of electric currents are indicated by arrows.

FIG. 6 is a circuit diagram showing the states of the voltages in the reset period T_{R} of the selection period T_{SE} of the ith row. As shown in FIG. 6, in the reset period T_{R} of the ith row, the selection scan driver 5 applies the ON voltage V_{ON} to the selection scan line Xᵢ, and the voltage supply driver 6 applies the tone designating current reference voltage V_{LOW} to the voltage supply line Zᵢ. In addition, in the reset period T_{R} of the ith row, the switches S₁ to Sₙ apply the reset voltage V_{R} to the current lines Y₁ to Yₙ. In the reset period T_{R} of the ith row, therefore, the first transistors 21 of the pixel circuits D_{i,1} to D_{i,n} are ON. Consequently, as shown in FIG. 4, the voltages of the pixel electrodes 51 of the organic EL elements E_{i,1} to E_{i,n}, the drains 21d of the first transistors 21 in the ith row, the electrodes 24B of the capacitors 24 in the ith row, the sources 23s of the driving transistors 23 in the ith row, and the current lines Y₁ to Yₙ are set in a steady state by the reset voltage V_{R}, thereby discharging the electric charge stored by these parasitic capacitances in the preceding selection period T_{SE}. Accordingly, the tone designating current I_{DATA} having a steady current value can be rapidly written in the next selection period T_{SE}.

The parasitic capacitances of the organic. EL elements E_{i,1} to E_{i,n} are particularly large. Therefore, when the tone designating current I_{DATA} having a low current value is written, it takes a long time to make the current value steady by resetting the electric charge written in the organic EL element in the preceding frame period T_{SC} if the reset voltage V_{R} is not applied in the selection period T_{SE}. However, the reset voltage V_{R} is forcedly applied in the selection period T_{SE}, so the parasitic capacitance of the organic EL element can be rapidly discharged. Also, when the reset voltage V_{R} of the ith row, which is applied in the selection period T_{SE} is made equal to that of the voltage supply line Zᵢ in the ith row, the voltages of the electrodes 24A and 24B of the capacitor 24 become equal to each other, so the electric charges written in the capacitor 24 in the preceding frame period T_{SC} are removed.

In addition, although the second transistors 22 and driving transistors 23 of the pixel circuits D_{i,1} to D_{i,n} are ON, the tone designating current reference voltage V_{LOW} equal to or lower than the reference voltage V_{SS} is applied to the voltage supply line Zᵢ, so the tone designating current I_{DATA} which flows from the voltage supply line Zᵢ to the driving transistors 23 does not flow through the organic EL elements E_{i,1} to E_{i,n}.

FIG. 7 is a circuit diagram showing the states of the electric currents and voltages after the reset period T_{R} in the selection period T_{SE} of the ith row. As shown in FIG. 7, after the reset period T_{R} in the selection period T_{SE} of the ith row, the selection scan driver 5 keeps applying the ON voltage V_{ON} to the selection scan line Xᵢ, and the voltage supply driver 6 keeps applying the tone designating current reference voltage V_{LOW} to the voltage supply line Zᵢ. In addition, after the reset period T_{R} in the selection period T_{SE} of the ith row, the current source driver 3 controls the switches S₁ to Sₙ to supply the tone designating current I_{DATA} from the current lines Y₁ to Yₙ to the current terminals CT₁ to CTₙ. In the selection period T_{SE} of the ith row, the second transistors 22 of the pixel circuits D_{i,1} to D_{i,n} in the ith row are ON. Since the second transistors 22 of the pixel circuits D_{i,1} to D_{i,n} are ON, the voltage is also applied to the gates 23g of the driving transistors 23 of the pixel circuits D_{i,1} to D_{i,n}, so the driving transistors 23 of the pixel circuits D_{i,1} to D_{i,n} are turned on. Furthermore, since the first transistors 21 of the pixel circuits D_{i,1} to D_{i,n} are also ON, the first transistors 21 of the pixel circuits D_{i,1} to D_{i,n} supply the tone designating current I_{DATA} from the voltage supply line Zᵢ to the current lines Y₁ to Yₙ via the drains 23d and sources 23s of the driving transistors 23. In this state, as shown in FIG. 4, the voltage of the current line Yⱼ drops until the tone designating current I_{DATA} becomes steady. Also, although the driving transistors 23 of the pixel circuits D_{i,1} to D_{i,n} are ON, the low-level tone designating current reference voltage V_{LOW} is applied to the voltage supply line Zᵢ, so no electric current flows from the voltage supply line Z₁ to the organic EL elements E_{i,1} to E_{i,n}. Therefore, the current value of the tone designating current I_{DATA} flowing through the current lines Y₁ to Yₙ becomes equal to the current value of the electric current I_{DS} between the drain 23d and source 23s of the driving transistor 23. In addition, the level of the voltage between the gate 23g and source 23s of the driving transistor 23 follows the current value of the tone designating current I_{DATA} which flows from the drain 23d to the source 23s. Accordingly, the driving transistor 23 converts the current value of the tone designating current I_{DATA} into the level of the voltage between the gate 23g and source 23s, and electric charges corresponding to the level of the voltage between the gate 23g and source 23s of the driving transistor 23 are held in the capacitor 24. Note that the gate 23g and drain 23d of the driving transistor 23 are connected via the second transistor 22, and the ON resistance of the second transistor 22 upon selection is negligibly low. Therefore, the voltage applied to the gate 23g and the voltage applied to the drain 23d of the driving transistor 23 are substantially equal, so the tone designating current I_{DATA} becomes the electric current I_{DS} which changes on the broken line V_{TH} shown in FIG. 5. That is, when the voltages of the gate 23g and drain 23d of the driving transistor 23 are equal, the voltage V_{DS} between the source 23s and drain 23d is equal to the threshold voltage V_{TH} between the unsaturated and saturated regions.

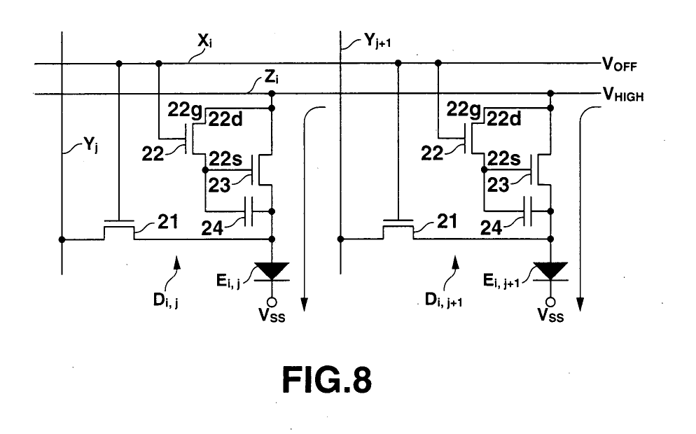

FIG. 8 is a circuit diagram showing the states of the electric currents and voltages in the non-selection period T_{NSE} of the ith row. As shown in FIG. 8, in the non-selection period T_{NSE} of the ith row, the selection scan driver 5 applies the OFF voltage V_{OFF} to the selection scan line Xᵢ, and the voltage supply driver 6 applies the driving current reference voltage V_{HIGH} to the voltage supply line Zᵢ.

In the non-selection period T_{NSE} of the ith row, the first transistors 21 of the pixel circuits D_{i,1} to D_{i,n} are OFF. Therefore, the first transistors 21 of the pixel circuits D_{i,1} to D_{i,n} shut off the tone designating current I_{DATA} flowing through the current lines Y₁ to Yₙ, thereby preventing an electric current from flowing from the voltage supply line Zᵢ to the current lines Y₁ to Yₙ via the driving transistors 23. In addition, since the second transistor 22 of each of the pixel circuits D_{i,1} to D_{i,n} in the ith row is turned off, the second transistor 22 confines the electric charges in the capacitor 24. In this manner, the second transistor 22 holds the level of the converted voltage between the gate 23g and source 23s of the driving transistor 23, thereby storing the current value of the electric current which flows through the source-to-drain path of the driving transistor 23. In this state, the high-level driving current reference voltage V_{HIGH} by which the source-to-drain voltage V_{DS} of the driving transistor 23 maintains the saturated region is applied to the voltage supply line Zᵢ, and the driving transistor 23 of each of the pixel circuits D_{i,1} to D_{i,n} is ON. Accordingly, each driving transistor 23 supplies the driving current from the voltage supply line Zᵢ to a corresponding one of the organic EL elements E_{i,1} to E_{i,n} to allow it to emit light at luminance corresponding to the current value of the driving current. In this state, the level of the converted voltage between the gate 23g and source 23s of the driving transistor 23 of each of the pixel circuits D_{i,1} to D_{i,n} is held by the capacitor 24 so as to be equal to the level of the voltage when the tone designating current I_{DATA} flows through a corresponding one of the current lines Y₁ to Yₙ in the second half of the selection period T_{SE}.

As shown in FIG. 5, a divided voltage V_{EL} of each of the organic EL elements E_{i,1} to E_{i,n} in the non-selection period T_{NSE} is obtained by subtracting, from the driving current reference voltage V_{HIGH}, the voltage V_{DS} on the EL load border line indicated by the alternate long and short dashed line, which is obtained when a driving current (equivalent to I_{DS} shown in FIG. 5) having a current value equal to that of the tone designating current I_{DATA} flows. That is, the voltage difference on the right side of the EL load border line is the divided voltage of one organic EL element. As described above, the divided voltage V_{EL} of the organic EL elements E_{i,1} to E_{i,n} rises as the luminance tone rises. In the non-selection period T_{NSE}, the driving current reference voltage V_{HIGH} is set higher than a voltage obtained by adding the divided voltage V_{EL} when the luminance tone of the organic EL elements E_{i,1} to E_{i,n} is a minimum to the ON resistance V_{DS} between the drain 23d and source 23s of the driving transistor at that time, and higher than a voltage obtained by adding the divided voltage V_{EL} when the luminance tone of the organic EL elements E_{i,1} to E_{i,n} is a maximum to the ON resistance V_{DS} between the drain 23d and source 23s of the driving transistor at that time. Also, in the non-selection period T_{NSE}, the voltage of the source 23s of the driving transistor 23 rises as the voltage V_{GS} between the gate 23g and source 23s, which is held in the selection period T_{SE} rises. Although the capacitor 24 changes the electric charge in the electrode 24B connected to the source 23s accordingly, the voltage V_{GS} between the gate 23g and source 23s is held constant by equally changing the electric charge in the electrode 24A.

As shown in FIG. 5, therefore, between the drain 23d and source 23s of the driving transistor 23 in the non-selection period T_{NSE} is always applied a saturated region voltage, and the current value of the driving current which flows through each of the organic EL elements E_{i,1} to E_{i,n} in the non-selection period T_{NSE} is made equal to the current value of the tone designating current I_{DATA} by the electric charges held between the gate 23g and source 23s in the selection period T_{SE}. Also, as shown in FIG. 4, the voltage of the pixel electrodes 51 of the organic EL elements E_{i,1} to E_{i,n} in the non-selection period T_{NSE} rises as the luminance tone rises. This increases the voltage difference between the pixel electrodes 51 and the common electrode as a cathode, and increases the luminance of the organic EL elements E_{i,1} to E_{i,n}.

As described above, the luminance (the unit is nit.) of the organic EL elements E_{i,1} to E_{i,n} is uniquely determined by the current value of the tone designating current I_{DATA} which flows through the pixel circuits D_{i,1} to D_{i,n} in the selection period T_{SE}.

A method of driving the organic EL display panel 2 by the current source driver 3, selection scan driver 5, voltage supply driver 6, and switches S₁ to Sₙ, and the display operation of the organic EL display 1 will be described below.

As shown in FIG. 4, the selection scan driver 5 applies the ON voltage VON in order from the selection scan line X₁ in the first row to the selection scan line Xₘ in the mth row (the selection scan line Xₘ in the mth row is followed by the selection scan line X₁ in the first row), thereby selecting these selection scan lines. In synchronism with this selection by the selection scan driver 5, the voltage supply driver 6 applies the tone designating current reference voltage V_{LOW} in order from the voltage supply line Z₁ in the first row to the voltage supply line Zₘ in the mth row (the voltage supply line Zₘ in the mth row is followed by the voltage supply line Z₁ in the first row), thereby selecting these voltage supply lines. In the selection period T_{SE} of each row, the current source driver 3 controls the current terminals CT₁ to CTₙ to generate the tone designating current I_{DATA} having a current value corresponding to the image signal.

Also, at the start of the selection period T_{SE} of each row (at the end of the selection period T_{SE} of the preceding row), the switching signal Φ changes from low level to high level, the switching signal inv. Φ changes from high level to low level, and the reset voltage V_{R} which removes the electric charges stored in the current lines Y₁ to Yₙ and the electric charges stored in the pixel electrodes 51 via the first transistors 21 is applied. In the selection period T_{SE} of each row (at the end of the reset period T_{R} of each row), the switching signal Φ changes from high level to low level, and the switching signal inv.Φ changes from low level to high level. In the reset period T_{R} in the initial part of the selection period T_{SE}, therefore, the switches S₁ to Sₙ allow the tone designating current I_{DATA} to flow between the current terminals CT₁ to CTₙ and current lines Y₁ to Yₙ, and shut down the application of the reset voltage V_{R} to the current lines Y₁ to Yₙ. After the reset period T_{R} in the selection period T_{SE}, the switches S₁ to Sₙ shut off the flow of the electric current between the current terminals CT₁ to CTₙ and current lines Y₁ to Yₙ, and allow the application of the reset voltage V_{R} to the current lines Y₁ to Yₙ.

The current value of the tone designating current I_{DATA} decreases as the luminance tone lowers. In this state, the voltages of the current lines Y₁ to Yₙ and pixel electrodes 51 approximate to the tone designating current reference voltage V_{LOW}, i.e., to the reset voltage V_{R}. Also, if the tone designating current I_{DATA} having a large current value flows in the selection period T_{SE} of the preceding row or of the preceding frame period T_{SC}, the voltage of the pixel electrodes 51 become much lower than the reset voltage V_{R} via the current lines Y₁ to Yₙ and first transistors 21.

If, therefore, no reset voltage is applied to the current lines Y₁ to Yₙ without forming the switches S₁ to Sₙ, and the tone designating current I_{DATA} having a low luminance tone and low current value is to be kept supplied to the ith row, the amount of electric charges to be modulated is large because the electric charges of the current lines Y₁ to Yₙ, which are stored in accordance with the tone designating current I_{DATA} having a large current value in the selection period T_{SE} of the (i−1)th row are held in the parasitic capacitances of the current lines Y₁ to Yₙ. Accordingly, it takes a long time to obtain a desired current value of the tone designating current I_{DATA}.

Likewise, if no reset voltage is applied to the pixel electrodes 51 in the selection period without forming the switches S₁ to Sₙ, and the tone designating current I_{DATA} having a low luminance tone and low current value is to be kept supplied in the next frame period T_{SC}, the amount of electric charges to be modulated are large because the electric charges of the pixel electrodes 51 in the ith row, which are stored in accordance with the tone designating current I_{DATA} having a large current value in the selection period T_{SE} of the frame period T_{SC} before the next frame period T_{SC} are held in the parasitic capacitances of the pixel electrodes 51 in the ith row. Accordingly, it takes a long time to obtain a desired current value of the tone designating current I_{DATA}.

In the selection period T_{SE}, therefore, no sufficient electric charges can be held so that the required voltage is obtained between the gate 23g and source 23s of the driving transistor 23. As a consequence, the driving current in the non-selection period T_{NSE} becomes different from the tone designating current I_{DATA}, and this makes accurate tone display impossible.

Since, however, the switches S₁ to Sₙ which apply the reset voltage V_{R} in the reset period T_{R} are provided, the electric charges stored in the current lines Y₁ to Yₙ and the electric charges stored in the pixel electrodes 51 via the first transistors 21 can be rapidly removed. Accordingly, the voltage between the gate 23g and source 23s of the driving transistor 23 can be rapidly set to a voltage by which the tone designating current I_{DATA} having a low luminance tone and low current value flows. Since this makes high-speed display possible, images particularly excellent in motion image characteristics can be displayed.

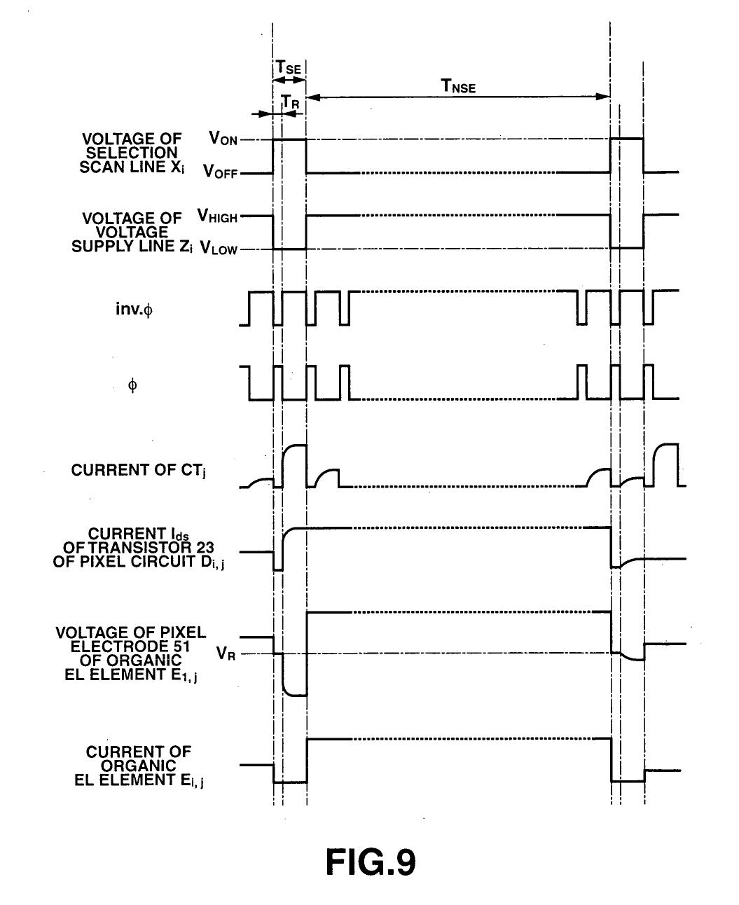

FIG. 9 is a timing chart showing, from above, the voltage of the selection scan line X₁, the voltage of the voltage supply line Z₁, the switching signal inv. Φ, the switching signal Φ, the current value of the current terminal CTⱼ, the current value of an electric current which flows through the driving transistor 23 of the pixel circuit D_{i,j}, the voltage of the pixel electrode 51 of the organic EL element E_{i,j}, and the current value of an electric current which flows through the organic EL element E_{i,j}. Referring to FIG. 9, the abscissa represents the common time.

As shown in FIGS. 6 and 9, when the selection scan driver 5 applies the ON voltage VON to the selection scan line Xᵢ in the ith row (i.e., in the selection period T_{SE} of the ith row), the OFF voltage V_{OFF} is applied to the other selection scan lines X₁ to Xₘ (except for Xᵢ). In the selection period T_{SE} of the ith row, therefore, the first and second transistors 21 and 22 of the pixel circuits D_{i,1} to D_{i,n} in the ith row are ON, and the first and second transistors 21 and 22 of the pixel circuits D_{1,1} to D_{m,n} (except for D_{i,1} to D_{i,n}) in the other rows are OFF.

As described above, in the selection period T_{SE} of the ith row, the tone designating current reference voltage V_{LOW} is applied to the voltage supply line Zᵢ, and the second transistors 22 of the pixel circuits D_{i,1} to D_{i,n} in the ith row are ON. Accordingly, the voltage is also applied to the gates 23g of the driving transistors 23 of the pixel circuits D_{i,1} to D_{i,n} in the ith row, so the driving transistors 23 are turned on.

In the reset period T_{R} in the initial part of the selection period T_{SE} of the ith row, the transistors 32 of the switches S₁ to Sₙ are turned on. Therefore, the voltage supply line Zᵢ is electrically connected to the reset input terminal 41 via the driving transistors 23 and first transistors 21 of the pixel circuits D_{i,1} to D_{i,n} and the current lines Y₁ to Yₙ. In this state, the voltage applied from the voltage supply line Zᵢ to the reset input terminal 41 via the driving transistors 23 and first transistors 21 of the pixel circuits D_{i,1} to D_{i,n} and the current lines Y₁ to Yₙ is equal to the reset voltage V_{R} (=tone designating current reference voltage V_{LOW}) which is equal to or lower than the reference voltage V_{SS}. Accordingly, the voltage of the pixel electrodes 51 of the organic EL elements E_{i,1} to E_{i,n} is also equal to the reset voltage V_{R}. In addition, since the reset voltage V_{R} is applied to the current lines Y₁ to Yₙ, the electric charges stored in the parasitic capacitances of the current lines Y₁ to Yₙ and the electric charges stored in the parasitic capacitances of the pixel circuits D_{i,1} to D_{i,n} including the pixel electrodes 51 are removed, so the voltage of these components becomes equal to the reset voltage V_{R}. As a consequence, the organic EL elements E_{i,1} to E_{i,n} stop emitting light immediately after the start of the reset period T_{R} of the ith row.

As shown in FIGS. 7 and 9, in the second half of the selection period T_{SE} after the reset period T_{R}, the ON voltage V_{ON} is applied to the selection scan line Xᵢ in the ith row, and the tone designating current reference voltage V_{LOW} is applied to the voltage supply line Zᵢ in the ith row. Therefore, the first transistors 21, second transistors 22, and driving transistors 23 of the pixel circuits D_{i,1} to D_{i,n} in the ith row are ON. After the reset period T_{R} in the selection period T_{SE}, the transistors 31 of the switches S₁ to Sₙ are turned on, so the switches S₁ to Sₙ allow an electric current to flow between the current terminals CT₁ to CTₙ and current lines Y₁ to Yₙ. As a consequence, the current terminals CT₁ to CTₙ are electrically connected to the voltage supply line Zᵢ in the ith row. In this state, the current source driver 3 supplies the tone designating current I_{DATA} from the voltage supply line Zᵢ to the current terminals CT₁ to CTₙ via the driving transistors 23 and first transistors 21 of the pixel circuits D_{i,1} to D_{i,n} the current lines Y₁ to Yₙ, and the switches S₁ to Sₙ. Until the end of the selection period T_{SE} of the ith row, the current source driver 3 controls the current value of the tone designating current I_{DATA} supplied to the current lines Y₁ to Yₙ such that the current value is held constant in accordance with the image signal.

In the second half of the selection period T_{SE} of the ith row, the tone designating current I_{DATA} flows along the voltage supply line Zᵢ→the path between the drain 23d and source 23s of the driving transistor 23 of each of the pixel circuits D_{i,1} to D_{i,n}→the path between the drain 21d and source 21s of the first transistor 21 of each of the pixel circuits D_{i,1} to D_{i,n}→the current lines Y₁ to Yₙ→the transistors 31 of the switches S₁ to Sₙ→the current terminals CT₁ to CTₙ of the current source driver 3. In the selection period T_{SE} of the ith row, therefore, the voltage applied from the voltage supply line Zᵢ to the current terminals CT₁ to CTₙ via the driving transistors 23 and first transistors 21 of the pixel circuits D_{i,1} to D_{i,n} and the current lines Y₁ to Yₙ becomes steady.

That is, since the voltage applied from the voltage supply line Zᵢ in the ith row to the current terminals CT₁ to CTₙ becomes steady, the voltage having a level corresponding to the current value of the tone designating current I_{DATA} which flows through the driving transistor 23 is applied between the gate 23g and source 23s of the driving transistor 23, so electric charges corresponding to the level of this voltage between the gate 23g and source 23s of the driving transistor 23 is held in the capacitor 24. Consequently, the current value of the tone designating current I_{DATA} which flows through the driving transistor 23 of each of the pixel circuits D_{i,1} to D_{i,n} in the ith row is converted into the level of the voltage between the gate 23g and source 23s of the driving transistor 23.

In the reset period T_{R} of the ith row as described above, the reset voltage V_{R} is applied to the current lines Y₁ to Yₙ. Therefore, the voltage applied from the voltage supply line Zᵢ to the reset input terminal 41 via the driving transistors 23 and first transistors 21 of the pixel circuits D_{i,1} to D_{i,n} and the current lines Y₁ to Yₙ can be made steady. Accordingly, even if a weak tone designating current I_{DATA} flows through the current lines Y₁ to Yₙ after the reset period T_{R} of the ith row, electric charges corresponding to the tone designating current I_{DATA} can be rapidly held in the capacitors 24 of the pixel circuits D_{i,1} to D_{i,n}.

As described above, the current value of the electric current which flows between the drain 23d and source 23s of the driving transistor 23 of each of the pixel circuits D_{i,1} to D_{i,n} in the ith row and the level of the voltage between the source 23s and gate 23g are overwritten from those of the preceding frame period T_{SC}. In the selection period T_{SE} Of the ith row, therefore, the magnitude of the electric charges which are held in the capacitor 24 of each of the pixel circuits D_{i,1} to D_{i,n} in the ith row is overwritten from that of the preceding frame period T_{SC}.

The potential at arbitrary points in the paths from the driving transistors 23 of the pixel circuits D_{i,1} to D_{i,n} to the current lines Y₁ to Yₙ via the first transistors 21 changes in accordance with, e.g., the internal resistances of the transistors 21, 22, and 23, which change with time. In this embodiment, however, in the selection period T_{SE}, the current source driver 3 forcedly supplies the tone designating current I_{DATA} from the driving transistors 23 of the pixel circuits D_{i,1} to D_{i,n} to the current lines Y₁ to Yₙ via the first transistors 21. Therefore, even if the internal resistances of the transistors 21, 22, and 23 change with time, the tone designating current I_{DATA} takes a desired current value.

Also, in the selection period T_{SE} of the ith row, the common electrode of the organic EL elements E_{i,1} to E_{i,n} in the ith row is at the reference voltage V_{SS}, and the voltage supply line Zᵢ is at the tone designating current reference voltage V_{LOW} which is equal to or lower than the reference voltage V_{SS}. As a consequence, a reverse bias voltage is applied to the organic EL elements E_{i,1} to E_{i,n} in the ith row. Accordingly, no electric current flows through the organic EL elements E_{i,1} to E_{i,n} in the ith row, so the organic EL elements E_{i,1} to E_{i,n} do not emit light.

Subsequently, as shown in FIGS. 8 and 9, at the end time of the selection period T_{SE} of the ith row (at the start time of the non-selection period T_{NSE} of the ith row), a signal output from the selection scan driver 5 to the selection scan line Xᵢ changes from the high-level ON voltage V_{ON} to the low-level OFF voltage V_{OFF}. That is, the selection scan driver 5 applies the OFF voltage V_{OFF} to the gate 21g of the first transistor 21 and the gate 22g of the second transistor 22 of each of the pixel circuits D_{i,1} to D_{i,n} in the ith row.

In the non-selection period T_{NSE} Of the ith row, therefore, the first transistors 21 of the pixel circuits D_{i,1} to D_{i,n} in the ith row are turned off to prevent the electric current from flowing from the voltage supply line Zᵢ to the current lines Y₁ to Yₙ. In addition, in the non-selection period T_{NSE} of the ith row, when the second transistors 22 of the pixel circuits D_{i,1} to D_{i,n} in the ith row are turned off, the electric charges held in the capacitors 24 in the immediately preceding selection period T_{SE} of the ith row are confined by the second transistors 22. Accordingly, the driving transistor 23 of each of the pixel circuits D_{i,1} to D_{i,n} in the ith row is kept ON in the non-selection period T_{NSE}. That is, in each of the pixel circuits D_{i,1} to D_{i,n} in the ith row, the voltage V_{GS} between the gate 23g and source 23s of the driving transistor 23 in the non-selection period T_{NSE} becomes equal to the voltage V_{GS} between the gate 23g and source 23s of the driving transistor 23 in the immediately preceding selection period T_{SE}, i.e., the capacitor 24 in which the electric charges on the side of the electrode 24A are held by the second transistor 22 holds the voltage V_{GS} between the gate 23g and source 23s of the driving transistor 23.

Also, in the non-selection period T_{NSE} of the ith row, the voltage supply driver 6 applies the driving current reference voltage V_{HIGH} to the voltage supply line Zᵢ in the ith row. In the non-selection period T_{NSE}, the common electrode of the organic EL elements E_{i,1} to E_{i,n} in the ith row is at the reference voltage V_{SS}, and the voltage supply line Zᵢ in the ith row is at the driving current reference voltage V_{HIGH} which is higher than the reference voltage V_{SS}, so the driving transistors 23 of the pixel circuits D_{i,1} to D_{i,n} in the ith row are ON. As a consequence, a forward bias voltage is applied to the organic EL elements E_{i,1} to E_{i,n}. In the pixel circuits D_{i,1} to D_{i,n}, therefore, a driving current flows from the voltage supply line Zᵢ to the organic EL elements E_{i,1} to E_{i,n} via the driving transistors 23, and thus the organic EL elements E_{i,1} to E_{i,n} emit light.

More specifically, in the pixel circuit D_{i,j} in the non-selection period T_{NSE} of the ith row, the first transistor 21 electrically shuts off the path between the current line Yⱼ and driving transistor 23, and the second transistor 22 confines the electric charges in the capacitor 24. In this manner, the level of the voltage, which is converted in the selection period T_{SE}, between the gate 23g and source 23s of the driving transistor 23 is held, and a driving current having a current value corresponding to the level of this voltage held between the gate 23g and source 23s is supplied to the organic EL element E_{i,j} by the driving transistor 23.

In this state, the current value of the driving current which flows through the organic EL elements E_{i,1} to E_{i,n} in the selection period T_{SE} of the ith row is equal to the current value of the electric current which flows through the driving transistors 23 of the pixel circuits D_{i,1} to D_{i,n}, and therefore equal to the current value of the tone designating current I_{DATA} which flows through the driving transistors 23 of the pixel circuits D_{i,1} to D_{i,n} in the selection period T_{SE}. As described above, in the selection period T_{SE}, the current value of the tone designating current I_{DATA} which flows through the driving transistors 23 of the pixel circuits D_{i,1} to D_{i,n} is a desired current value. Therefore, a driving current having a desired current value can be supplied to the organic EL elements E_{i,1} to E_{i,n}, so the organic EL elements E_{i,1} to E_{i,n} can emit light at a desired tone luminance.

In the reset period T_{R} of the (i+1)th row after the selection period T_{SE} of the ith row, as in the reset period T_{R} of the ith row, the transistors 31 of the switches S₁ to Sₙ are turned off, and the transistors 32 of the switches S₁ to Sₙ are turned on. Accordingly, in the reset period T_{R} of the (i+1)th row, the tone designating current I_{DATA} does not flow through any of the current lines Y₁ to Yₙ, but the reset voltage V_{R} is applied to all the current lines Y₁ to Yₙ, the pixel electrodes 51 in the (i+1)th row, the electrodes 24B of the capacitors 24 in the (I+1)th row, and the sources 23s of the driving transistors 23 in the (i+1)th row. After the reset period T_{R} in the selection period T_{SE} of the (i+1)th row, as in the case of the ith row, the selection scan driver 5 selects the selection scan line Xᵢ₊₁ in the (i+1)th row, so the tone designating current I_{DATA} flows from the voltage supply line Zᵢ to the current terminals CT₁ to CTₙ via the driving transistors 23 and first transistors 21 of the pixel circuits D_{i,1} to D_{i,n}, the current lines Y₁ to Yₙ, and the switches D_{i,1} to D_{i,n}.

As described above, in the reset period T_{R}, the reset voltage V_{R} is forcedly applied to, e.g., the current lines Y₁ to Yₙ and the pixel electrodes 51. Therefore, the charge amount of the parasitic capacitances of the current lines Y₁ to Yₙ and the like approximates to the charge amount in a steady state in which a small electric current flows. Accordingly, even when the electric current which flows through the current lines Y₁ to Yₙ after the reset period T_{R} of the (i+1)th row is weak, a steady state can be immediately obtained.

In this embodiment as described above, the current value of the driving current which flows through the organic EL elements E_{1,1} to E_{m,n} in the non-selection period T_{NSE} is represented by the current value of the tone designating current I_{DATA} after the reset period T_{R} of the selection period T_{SE}. Therefore, even when variations are produced in characteristics of the driving transistors 23 of the pixel circuits D_{1,1} to D_{m,n}, no variations are produced in luminance of the organic EL elements E_{1,1} to E_{m,n} if the current value of the tone designating current I_{DATA} remains the same for all the pixel circuits D_{1,1} to D_{m,n}. That is, this embodiment can suppress planar variations by which pixels have different luminance values even though luminance tone signals having the same level are output to these pixels. Accordingly, the organic EL display 1 of this embodiment can display high-quality images.

The tone designating current I_{DATA} is very weak because it is equal to the current value of the electric current which flows through the organic EL elements E_{1,1} to E_{m,n} in accordance with the luminance of the organic EL elements E_{1,1} to E_{m,n} which emit light. The wiring capacitances of the current lines Y₁ to Yₙ delay the tone designating current I_{DATA} which flows through the current lines Y₁ to Yₙ. If the selection period T_{SE} is short, therefore, electric charges corresponding to the tone designating current I_{DATA} cannot be held in the gate-to-source path of the driving transistor 23. In this embodiment, however, the reset voltage V_{R} is forcedly applied to the current lines Y₁ to Yₙ in the reset period T_{R} of each row. Therefore, even if the tone designating current I_{DATA} is weak or the selection period T_{SE} is short, electric charges corresponding to the tone designating current I_{DATA} can be held in the gate-to-source path of the driving transistor 23 within the selection period T_{SE}.

Also, in this embodiment, the data driving circuit 7 applies the reset voltage V_{R} to the current lines Y₁ to Yₙ in the selection period T_{SE}. Therefore, the first transistor 21 has both the function of a switching element which loads the reset voltage V_{R} into each of the pixel circuits D_{1,1} to D_{m,n}, and the function of a switching element which loads the tone designating current I_{DATA} into each of the pixel circuits D_{1,1} to D_{m,n}. This makes it unnecessary to form any switching T_{FT}, which loads a blanking signal into a pixel circuit as in the conventional device (Jpn. Pat. Appln. KOKAI Publication No. 2000-221942), in the pixel circuits D_{1,1} to D_{m,n} in addition to the first transistors 21. Accordingly, the number of transistors necessary for the pixel circuits D_{1,1} to D_{m,n} does not increase. When the organic EL elements E_{1,1} to E_{m,n} are formed on the same surface as the pixel circuits D_{1,1} to D_{m,n}, therefore, the aperture ratio of the pixels P_{1,1} to P_{m,n} does not decrease.

### Second Embodiment

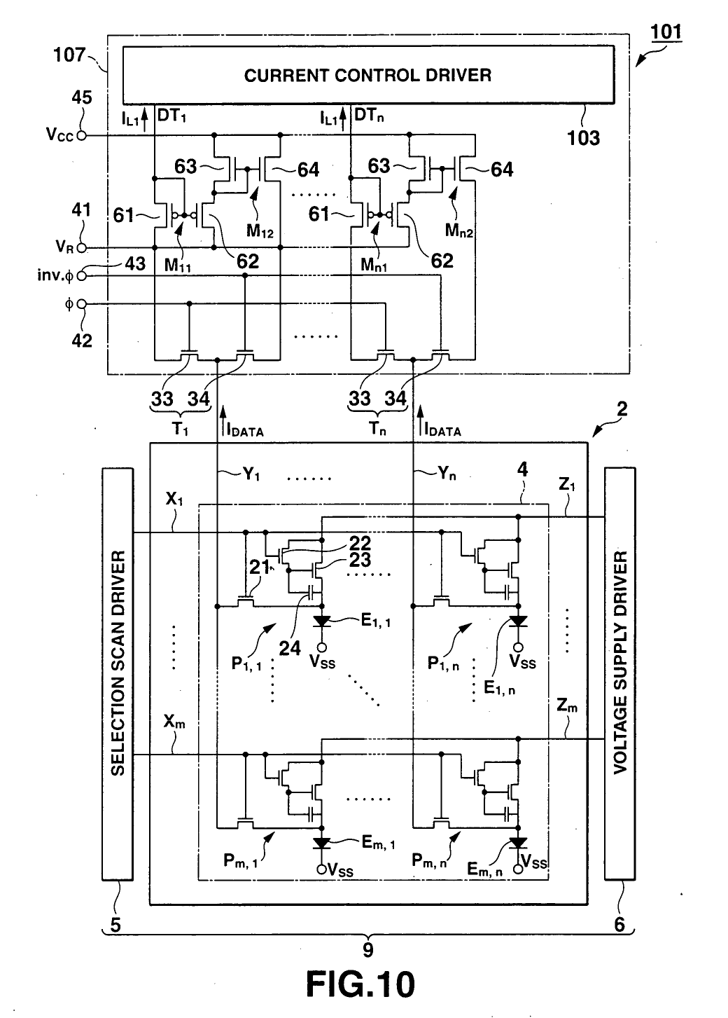

FIG. 10 is a block diagram showing an organic EL display 101 according to the second embodiment to which the organic EL display of the present invention is applied. In FIG. 10, the same reference numerals and symbols as in the organic EL display 1 of the first embodiment denote the same parts in the organic EL display 101, and an explanation thereof will be omitted.

Similar to the organic EL display 1 shown in FIG. 1, the organic EL display 101 includes an organic EL display panel 2, scan driving circuit 9, and data driving circuit 107. The organic EL display panel 2 and scan driving circuit 9 are the same as the organic EL display panel 2 and scan driving circuit 9 of the first embodiment. The data driving circuit 107 is different from the data driving circuit 7 of the first embodiment.

The data driving circuit 107 includes n current terminals DT₁ to DTₙ, a current control driver 103 which supplies a pull current I_{L1} to the current terminals DT₁ to DTₙ, first current mirror circuits M₁₁ to Mₙ₁ and second current mirror circuits M₁₂ to Mₙ₂ which convert the pull current I_{L1} flowing through the current terminals DT₁ to DTₙ into a tone designating current I_{DATA}, and switches T₁ to Tₙ interposed between current lines Y₁ to Yₙ, the first current mirror circuits M₁₁ to Mₙ₁, and the second current mirror circuits M₁₂ to Mₙ₂.

An 8-bit digital tone image signal is input to the current control driver 103. This digital tone image signal loaded into the current control driver 103 is converted into an analog signal by an internal D/A converter of the current control driver 103. The driver 103 generates the pull current I_{L1} having a current value corresponding to the analog image signal at the current terminals DT₁ to DTₙ. The driver 103 supplies the pull current I_{L1} from the first current mirror circuits M₁₁ to Mₙ₁ formed for individual rows to the current terminals DT₁ to DTₙ. In accordance with the pull current I_{L1}, the current control driver 103 supplies the tone designating current I_{DATA} from driving transistors 23 in the individual rows to the second current mirror circuits M₁₂ to Mₙ₂ via the current lines Y₁ to Yₙ.

The operation timings of the current control driver 103 are the same as those of the current source driver 3 of the first embodiment. That is, the current control driver 103 controls the current value of the pull current I_{L1} at the current terminals DT₁ to DTₙ in each selection period T_{SE} of each row in accordance with the image signal, and makes the current value of the pull current I_{L1} steady in a period from the end of each reset period T_{R} to the end of the corresponding selection period T_{SE}. The pull current I_{L1} supplied by the current control driver 103 is larger than and proportional to the tone designating current I_{DATA} supplied by the current source driver 3 of the first embodiment.

The first current mirror circuits M₁₁ to Mₙ₁ and second current mirror circuits M₁₂ to Mₙ₂ convert the pull current I_{L1} which flows through the current terminals DT₁ to DTₙ into the tone designating current I_{DATA} at a predetermined conversion ratio. Each of the first current mirror circuits M₁₁ to Mₙ₁ is made up of two P-channel MOS transistors 61 and 62. The transistors 61 and 62 can be fabricated by the same steps as the transistors 21 to 23 of each of pixel circuits D_{1,1} to D_{m,n}. Each of the second current mirror circuits M₁₂ to Mₙ₂ is made up of two N-channel MOS transistors 63 and 64. The transistors 63 and 64 can be partially fabricated by the same steps as the transistors 21 to 23 of each of the pixel circuits D_{1,1} to D_{m,n}.

In the first current mirror circuits M₁₁ to Mₙ₁, the gates and drains of the transistors 61 and the gates of the transistors 62 are connected to the current terminals DT₁ to DTₙ. The sources of the transistors 61 and 62 are connected to a reset input terminal 41 which outputs a reset voltage V_{R} as a ground voltage.

In the second current mirror circuits M₁₂ to Mₙ₂, the gates and drains of the transistors 63 and the gates of the transistors 64 are connected together to the drains of the transistors 62. The sources of the transistors 63 and 64 are connected to a constant-voltage input terminal 45 to which a negative voltage V_{CC} is applied, and the drains of the transistors 64 are connected to the sources of transistors 34 of the switches T₁ to Tₙ (to be described later). In each of the first current mirror circuits M₁₁ to Mₙ₁, the channel resistance of the transistor 61 is lower than that of the transistor 62. In each of the second current mirror circuits M₁₂ to Mₙ₂, the channel resistance of the transistor 63 is lower than that of the transistor 64.

Each of the switches T₁ to Tₙ has an N-channel MOS transistor 33 and the N-channel MOS transistor 34. The transistors 33 and 34 can be fabricated by the same steps as the transistors 21 to 23 of each of the pixel circuits D_{1,1} to D_{m,n}. An example of the switch Tⱼ will be explained below. The gate of the transistor 34 of the switch Tⱼ is connected to a switching signal input terminal 43, and thus a switching signal inv.Φ is input to the gate of the transistor 34. Also, the gate of the transistor 33 is connected to a switching signal input terminal 42, and thus a switching signal Φ is input to the gate of the transistor 33. The drains of the transistors 33 and 34 are connected to the current line Yⱼ, the source of the transistor 33 is connected to the source of the transistor 61 of the first current mirror circuit Mᵢ₁ and the reset input terminal 41, and the source of the transistor 34 is connected to the drain of the transistor 64 of the second current mirror circuit Mᵢ₂.

In this arrangement, when the switching signal Φ is at high level and the switching signal inv.Φ is at low level, the transistor 33 is turned on, and the transistor 34 is turned off. The switching signals Φ and inv.Φ have the same waveforms as in FIG. 4 of the first embodiment. Accordingly, the switches T₁ to Tₙ switch the state in which the tone designating current I_{DATA} obtained by modulating the current value of the pull current I_{L1} by the first current mirror circuits M₁₁ to Mₙ₁ and second current mirror circuits M₁₂ to Mₙ₂ is supplied to the driving transistors 23 and current lines Y₁ to Yₙ, and the state in which the reset voltage V_{R} is applied to the current lines Y₁ to Yₙ.

When the current control driver 103 supplies the pull current I_{L1} to the current terminal DTⱼ, an electric current which flows through the drain-to-source path of the transistor 62 in the first current mirror circuit Mⱼ₁ has a value obtained by multiplying the ratio of the channel resistance of the transistor 62 to that of the transistor 61 by the current value of the pull current I_{L1} in the drain-to-source path of the transistor 61. In the second current mirror circuit Mⱼ₂, an electric current which flows through the drain-to-source path of the transistor 64 has a value obtained by multiplying the ratio of the channel resistance of the transistor 64 to that of the transistor 63 by the current value of an electric current in the drain-to-source path of the transistor 63. The current value of the electric current in the drain-to-source path of the transistor 63 matches the electric current which flows through the drain-to-source path of the transistor 62. Therefore, the current value of the tone designating current I_{DATA} is obtained by multiplying the ratio of the channel resistance of the transistor 64 to that of the transistor 63 by the value which is obtained by multiplying the ratio of the channel resistance of the transistor 62 to that of the transistor 61 by the current value of the pull current I_{L1} in the drain-to-source path of the transistor 61.

As described above, the first current mirror circuits M₁₁ to Mₙ₁ and second current mirror circuits M₁₂ to Mₙ₂ convert the pull current I_{L1} which flows through the current terminals DT₁ to DTₙ into the tone designating current I_{DATA}. Since the tone designating current I_{DATA} flows through the output sides of the second current mirror circuits M₁₂ to Mₙ₂, i.e., the drains of the transistors 64, these drains of the transistors 64 of the second current mirror circuits M₁₂ to Mₙ₂ are equivalent to the current terminal CTⱼ of the current source driver 3 of the first embodiment. That is, an arrangement obtained by combining the first current mirror circuits M₁₁ to Mₙ₁, second current mirror circuits M₁₂ to Mₙ₂, and current control driver 103 is equivalent to the current source driver 3 of the first embodiment.

In the first embodiment, the reset voltage V_{R} is at the same level as the tone designating current reference voltage V_{LOW}. In the second embodiment, however, the reset voltage V_{R} is set at 0 [V]. Therefore, when a voltage V_{SS} is set at the ground voltage, no voltage difference is produced between pixel electrodes 51 as the anodes of the organic EL elements E_{1,1} to E_{m,n} and the common electrode as the cathode. As a consequence, electric charges stored in the pixel electrodes 51 can be easily removed.

In order for the switches T₁ to Tₙ to perform the switching operation, as in the first embodiment, the switching signal Φ is input to the switching signal input terminal 42, and the switching signal inv.Φ is input to the switching signal input terminal 43. The relationship between the timings of the switching signals Φ and inv.Φ and the selection timings of a selection scan driver 5 and voltage supply driver 6 is the same as in the first embodiment. Also, the operation timings of the selection scan driver 5 and voltage supply driver 6 in the second embodiment are the same as in the first embodiment.

In the second embodiment, as in the first embodiment, in the reset period T_{R} of the former period in the selection period T_{SE} of the ith row, the transistors 33 of the switches T₁ to Tₙ are turned on, so a voltage supply line Zᵢ is electrically connected to the reset input terminal 41 via the driving transistors 23 and first transistors 21 of the pixel circuits D_{i,1} to D_{i,n} and the current lines Y₁ to Yₙ.

Also, in the reset period T_{R} of the ith row, the reset voltage V_{R} is applied to the current lines Y₁ to Yₙ and pixel electrodes 51, so the electric charges stored in the parasitic capacitances of the current lines Y₁ to Yₙ and the electric charges stored in the parasitic capacitances of the pixel electrodes 51 can be rapidly removed. Accordingly, even when the weak tone designating current I_{DATA} flows through the current lines Y₁ to Yₙ after the reset period T_{R} of the ith row, electric charges corresponding to the tone designating current I_{DATA} can be rapidly held in capacitors 24 of the pixel circuits D_{i,1} to D_{i,n}.

In addition, in a non-selection period T_{NSE}, the current value of a driving current which flows through the organic EL elements E_{1,1} to E_{m,n} is represented by the current value of the tone designating current I_{DATA} after the reset period T_{R} of each selection period T_{SE}. Therefore, even if variations are produced in characteristics of the driving transistors 23 of the pixel circuits D_{1,1} to D_{m,n}, no variations are produced in driving current because the tone designating current I_{DATA} is forcedly supplied to the driving transistors 23. As a consequence, no variations are produced in luminance of the organic EL elements E_{1,1} to E_{m,n}.

Furthermore, since the first current mirror circuits M₁₁ to Mₙ₁ and second current mirror circuits M₁₂ to Mₙ₂ are formed, the current value of the tone designating current I_{DATA} of the current lines Y₁ to Yₙ is proportional to and smaller than the pull current I_{L1} at the current terminals DT₁ to DTₙ. Accordingly, even if the pull current I_{L1} at the current terminals DT₁ to DTₙ is unexpectedly reduced by a leakage current produced in the current control driver 103 or the like, the tone designating current I_{DATA} of the current lines Y₁ to Yₙ does not largely reduce. That is, even a decrease in output from the current control drive 103 caused by a current leak has no large influence on the tone designating current I_{DATA} Of the current lines Y₁ to Yₙ, so the luminance of the organic EL elements E_{1,1} to E_{m,n} does not largely decrease.

In the second embodiment, the data driving circuit 107 can well generate the tone designating current I_{DATA} even when the current control driver 103 cannot generate a weak electric current close to the tone designating current I_{DATA} matching the light emission characteristics of the organic EL elements.

The data driving circuit 107 applies the reset voltage V_{R} to the current lines Y₁ to Yₙ in the selection period T_{SE} in the second embodiment as well. Therefore, the first transistor 21 has both the function of a switching element which loads the reset voltage V_{R} into each of the pixel circuits D_{1,1} to D_{m,n}, and the function of a switching element which loads the tone designating current I_{DATA} into each of the pixel circuits D_{1,1} to D_{m,n}. Accordingly, the number of transistors necessary for the pixel circuits D_{1,1} to D_{m,n} does not increase. When the organic EL elements E_{1,1} to E_{m,n} are formed on the same surface as the pixel circuits D_{1,1} to D_{m,n}, therefore, the aperture ratio of the pixels P_{1,1} to P_{m,n} does not decrease.

### Third Embodiment

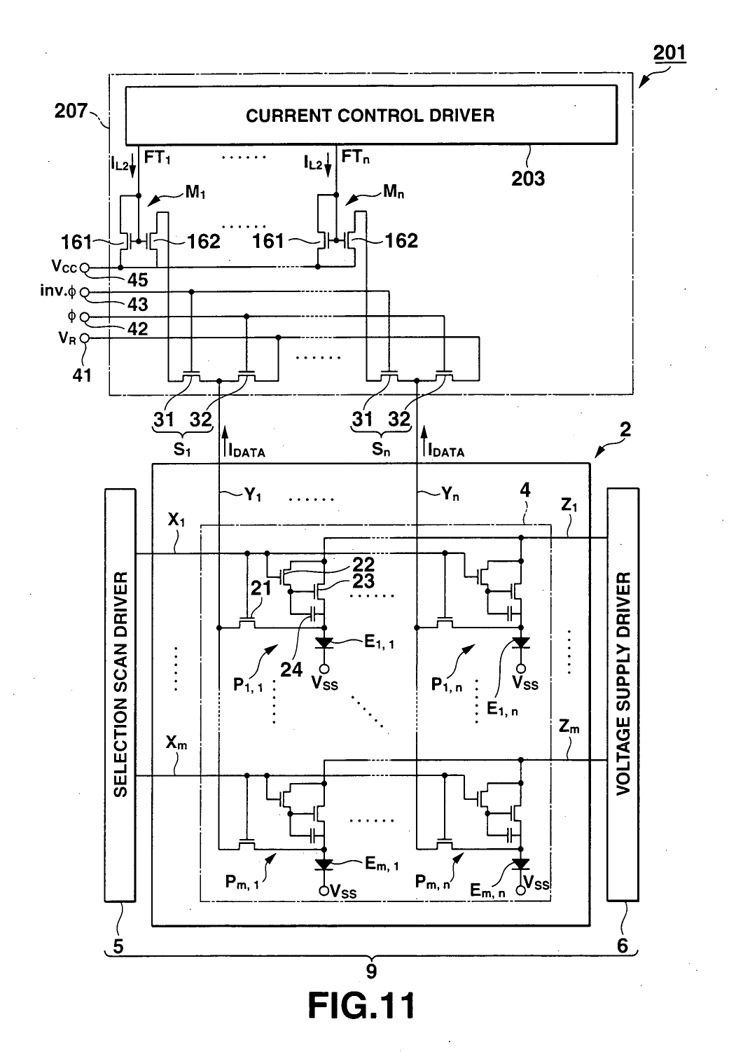

FIG. 11 is a block diagram showing an organic EL display 201 according to the third embodiment to which the organic EL display of the present invention is applied. In FIG. 11, the same reference numerals and symbols as in the organic EL display 1 of the first embodiment denote the same parts in the organic EL display 201, and an explanation thereof will be omitted.

Similar to the organic EL display 1, the organic EL display 201 includes an organic EL display panel 2, scan driving circuit 9, and data driving circuit 207. The organic EL display panel 2 and scan driving circuit 9 are the same as the organic EL display panel 2 and scan driving circuit 9 of the first embodiment. The data driving circuit 207 is different from the data driving circuit 7 of the first embodiment.

The data driving circuit 207 includes a current control driver 203 which has n current terminals FT₁ to FTₙ and supplies a push current I_{L2} to the current terminals FT₁ to FTₙ, current mirror circuits M₁ to Mₙ for converting the push current I_{L2} flowing through the current terminals FT₁ to FTₙ, and switches S₁ to Sₙ interposed between current lines Y₁ to Yₙ and the current mirror circuits M₁ to Mₙ.

In the second embodiment, the current control driver 103 supplies the pull current I_{L1} from the current mirror circuits M₁ to Mₙ to the current terminals DT₁ to DTₙ. In the third embodiment, the current control driver 203 supplies the push current I_{L2} from the current terminals FT₁ to FTₙ to the current mirror circuits M₁ to Mₙ.

Each of the current mirror circuits M₁ to Mₙ is made up of two N-channel MOS transistors 161 and 162. The transistors 161 and 162 can be fabricated by the same steps as transistors 21 to 23 of pixel circuits D_{1,1} to D_{m,n}.

In each of the current mirror circuits M₁ to Mₙ, the gate and drain of the transistor 161 and the gate of the transistor 162 are connected together, and the sources of the transistors 161 and 162 are connected to a constant-voltage input terminal 45. A constant voltage V_{CC} is applied to the constant-voltage input terminal 45. The level of the constant voltage V_{CC} is lower than a tone designating current reference voltage V_{LOW} and reference voltage V_{SS}. When the reference voltage V_{SS} or tone designating current reference voltage V_{LOW} is 0 [V] as in the first embodiment, the constant voltage V_{CC} is a negative voltage.

An example of the switch Sⱼ will be explained below. The switch Sⱼ is made up of N-channel field-effect transistors 31 and 32. The gate of the transistor 31 is connected to a switching signal input terminal 43, and thus a switching signal inv.Φ is input to the gate of the transistor 31. Also, the gate of the transistor 32 is connected to a switching signal input terminal 42, and thus a switching signal Φ is input to the gate of the transistor 32. The drain of the transistor 31 is connected to the current line Yⱼ, and the source of the transistor 31 is connected to the drain of the transistor 162. The drain of the transistor 32 is connected to the current line Yⱼ. The source of the transistor 32 is connected to a reset input terminal 41, and thus a reset voltage V_{R} as a constant voltage is applied to the source of the transistor 32. In this arrangement, when the switching signal Φ is at high level and the switching signal inv.Φ is at low level, the transistor 32 is turned on, and the transistor 31 is turned off. When the switching signal Φ is at low level and the switching signal inv.Φ is at high level, the transistor 31 is turned on, and the transistor 32 is turned off. The transistors 31 and 32 can be fabricated by the same steps as the transistors 21 to 23 of the pixel circuits D_{1,1} to D_{m,n}. The reset voltage V_{R} is preferably 0 [V] in order to completely discharge, e.g., the electric charges stored in the parasitic capacitances of the current lines Y₁ to Yₙ and the electric charges stored in the parasitic capacitances of pixel electrodes 51.

The current control driver 203 controls the current value of the push current I_{L2} at the current terminals FT₁ to FTₙ in accordance with the image signal in each selection period T_{SE} of each row, and holds the magnitude of the push current I_{L2} constant in a period from the end of each reset period T_{R} to the end of the corresponding selection period T_{SE}. The push current I_{L2} supplied by the current control driver 203 is larger than and proportional to the tone designating current I_{DATA} supplied by the current source driver 3 of the first embodiment.

The channel resistance of the transistor 161 is lower than that of the transistor 162. Therefore, the current mirror circuits M₁ to Mₙ convert the push current I_{L2} which flows through the current terminals FT₁ to FTₙ into a tone designating current I_{DATA}. The current value of the tone designating current I_{DATA} is substantially a value obtained by multiplying the ratio of the cannel resistance of the transistor 161 to that of the transistor 162 by the current value of the push current I_{L2} in the drain-to-source path of the transistor 161. Since the tone designating current I_{DATA} flows through the output sides of the current mirror circuits M₁ to Mₙ, i.e., the drains of the transistors 162, these drains of the transistors 162 of the current mirror circuits M₁ to Mₙ are equivalent to the current terminals CT₁ to CTₙ of the current source driver 3 of the first embodiment. That is, an arrangement obtained by combining the current mirror circuits M₁ to Mₙ and current control driver 203 is equivalent to the current source driver 3 of the first embodiment.

The relationship between the timings of the switching signals Φ and inv.Φ and the selection timings of the selection scan driver 5 and voltage supply driver 6 in this embodiment is the same as in the first embodiment. Also, the operation timings of the selection scan driver 5 and voltage supply driver 6 in the third embodiment are the same as in the first embodiment. Therefore, in the reset period T_{R} of the ith row, the first transistors 21 of the pixel circuits D_{1,1} to D_{m,n} are ON in the third embodiment as well. Accordingly, the voltages of the pixel electrodes 51 of organic EL elements E_{i,1} to E_{i,n}, drains 21d of the first transistors 21 in the ith row, electrodes 24B of capacitors 24 in the ith row, sources 23s of the driving transistors 23 in the ith row, and the current lines Y₁ to Yₙ are set in a steady state, thereby removing the electric charges stored in these parasitic capacitances in the preceding selection period T_{SE}. Consequently, the tone designating current I_{DATA} can be rapidly and accurately written in the next selection period T_{SE}.

The data driving circuit 207 applies the reset voltage V_{R} to the current lines Y₁ to Yₙ in the selection period T_{SE} in the third embodiment as well. Therefore, the first transistor 21 has both the function of a switching element which loads the reset voltage V_{R} into each of the pixel circuits D_{1,1} to D_{m,n}, and the function of a switching element which loads the tone designating current I_{DATA} into each of the pixel circuits D_{1,1} to D_{m,n}. Accordingly, the number of transistors necessary for the pixel circuits D_{1,1} to D_{m,n} does not increase. When the organic EL elements E_{1,1} to E_{m,n} are formed on the same surface as the pixel circuits D_{1,1} to D_{m,n}, therefore, the aperture ratio of the pixels P_{1,1} to P_{m,n} does not decrease.

### Fourth Embodiment

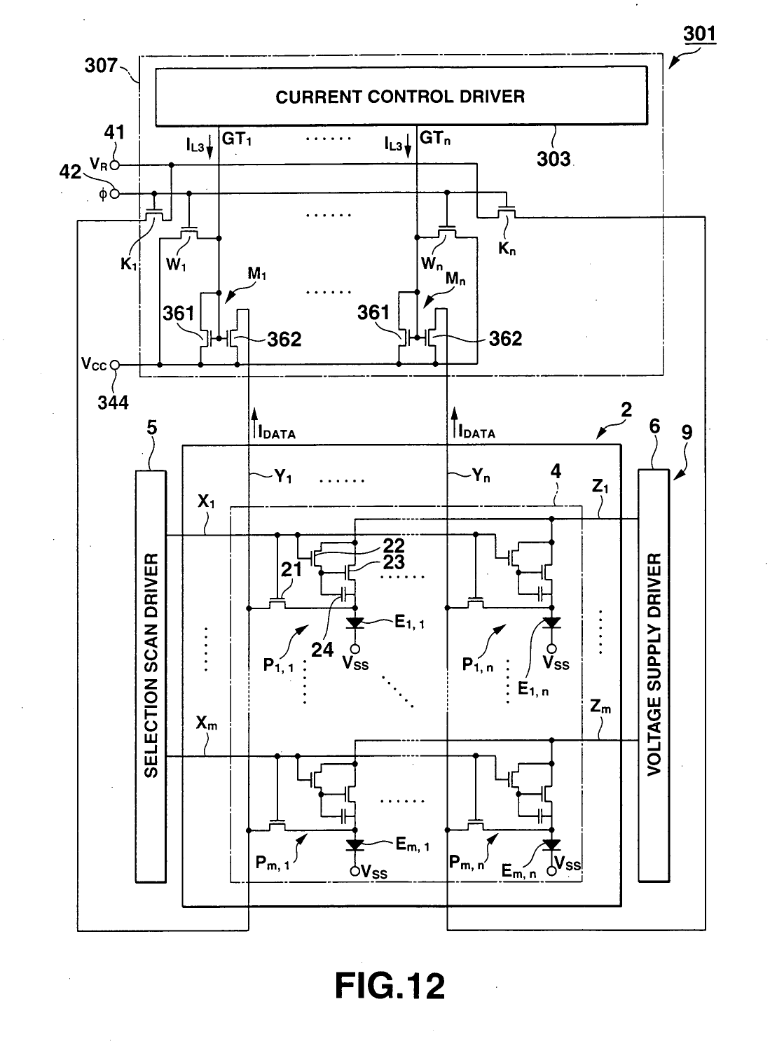

FIG. 12 is a block diagram showing an organic EL display 301 according to the fourth embodiment to which the organic EL display of the present invention is applied. In FIG. 12, the same reference numerals and symbols as in the organic EL display 1 of the first embodiment denote the same parts in the organic EL display 301, and an explanation thereof will be omitted.

Similar to the organic EL display 1, the organic EL display 301 includes an organic EL display panel 2, scan driving circuit 9, and data driving circuit 307. The organic EL display panel 2 and scan driving circuit 9 are the same as the organic EL display panel 2 and scan driving circuit 9 of the third embodiment. The data driving circuit 307 is different from the data driving circuit 7 of the first embodiment.

The data driving circuit 307 includes a current control driver 303, current mirror circuits M₁ to Mₙ, switching elements K₁ to Kₙ, and switching elements W₁ to Wₙ as switches.

The current control driver 303 has n current terminals GT₁ to GTₙ. An 8-bit digital tone image signal is input to the current control driver 303. This digital tone image signal loaded into the current control driver 303 is converted into an analog signal by an internal D/A converter of the current control driver 303. The current control driver 303 generates a push current I_{L3} having a current value corresponding to the analog image signal at the current terminals GT₁ to GTₙ. The current control driver 303 controls the current value of the push current I_{L3} at the current terminals GT₁ to GTₙ in each selection period T_{SE} of each row in accordance with the image signal, and holds the current value of the push current I_{L3} constant in a period from the end of each reset period T_{R} to the end of the corresponding selection period T_{SE}. The push current I_{L3} supplied by the current control driver 303 is larger than the tone designating current I_{DATA} supplied by the current source driver 3 of the first embodiment, and proportional to a tone designating current I_{DATA} which flows through a transistor 362 (to be described later).

The current mirror circuits M₁ to M₁ convert the push current I_{L3} which flows through the current terminals GT₁ to GTₙ into the tone designating current I_{DATA}. Each of the current mirror circuits M₁ to Mₙ has two transistors 361 and 362. In the current mirror circuit Mⱼ, the gate of the transistor 361 is connected to the gate of the transistor 362, and the drain of the transistor 361 is connected to the current terminal and to the gates of the transistors 361 and 362. The drain of the transistor 362 is connected to a current line Yⱼ. The sources of the transistors 361 and 362 are connected to a common voltage terminal 344. A constant voltage V_{CC} is applied to the voltage terminal 344. The level of the constant voltage V_{CC} is lower than a tone designating current reference voltage V_{LOW} and reference voltage V_{SS}. When the reference voltage V_{SS} or tone designating current reference voltage V_{LOW} is 0 [V] as in the first embodiment, the constant voltage V_{CC} is a negative voltage.

The current value of the tone designating current I_{DATA} is substantially a value obtained by multiplying the ratio of the cannel resistance of the transistor 362 to that of the transistor 361 by the current value of the push current I_{L3} in the drain-to-source path of the transistor 361. That is, an arrangement obtained by combining the current mirror circuits M₁ to Mₙ and current control driver 303 is equivalent to the current source driver.

The drains of the transistors or switching elements W₁ to Wₙ are connected to the current terminals GT₁ to GTₙ and to the drains and gates of the transistors 361 of the current mirror circuits M₁ to Mₙ. The sources of the switching elements W₁ to Wₙ are connected to the voltage terminal 344. The gates of the switching elements W₁ to Wₙ are connected to a switching signal input terminal 42. The switching elements W₁ to Wₙ switch the application of the constant voltage V_{CC} to the drains of the transistors 361 of the current mirror circuits M₁ to Mₙ. Note that the switching elements W₁ to Wₙ may also be incorporated into the current control driver 303.

The relationship between the timings of switching signals and the selection timings of a selection scan driver 5 and voltage supply driver 6 in this embodiment is the same as in the first embodiment.

In the reset period T_{R} in the initial part of the selection period T_{SE} of the ith row, therefore, the transistors W₁ to Wₙ are turned on, so the voltages of the sources and drains of the transistors 361 become equal to each other. Accordingly, after the reset period T_{R} of the selection period T_{SE}, the influence of the parasitic capacitances of the current mirror circuits M₁ to Mₙ on the current lines Y₁ to Yₙ can be removed.

In each of switching elements K₁ to Kₙ, one of the drain and source is connected to a reset input terminal 41, the other of the drain and source is connected to a corresponding one of the current lines Y₁ to Yₙ, and the gate is connected to the switching signal input terminal 42. The switching elements K₁ to Kₙ switch the application of the reset voltage V_{R} to the current lines Y₁ to Yₙ. The reset voltage V_{R} is set at 0 [V]. Note that on the opposite side of the connecting portion between each of the current lines Y₁ to Yₙ and the transistor 362, the other of the drain and source of a corresponding one of the switching elements K₁ to Kₙ may also be connected to a corresponding one of the current lines Y₁ to Yₙ, and the switching elements K₁ to Kₙ may also be formed on the organic EL display panel 2.

In the reset period T_{R} in the initial part of the selection period T_{SE} of the ith row, the switching elements K₁ to Kₙ are turned on, so pixel electrodes 51 and the current lines Y₁ to Yₙ electrically conduct to the reset input terminal 41 to apply the grounded reset voltage V_{R}. Therefore, immediately after the start of the reset period T_{R} of the ith row, it is possible to remove the electric charges stored in the parasitic capacitances of the current lines Y₁ to Yₙ, the electric charges stored in the parasitic capacitances of the pixel electrodes 51, the electric charges stored in the parasitic capacitances of electrodes 24B of capacitors 24, and the electric charges stored in the parasitic capacitances of the sources of driving transistors 23. Accordingly, the tone designating current I_{DATA} having a very small current value can be accurately and rapidly supplied. After the reset period T_{R}, the switching elements K₁ to Kₙ and W₁ to Wₙ are turned off, and an electric current having a current value corresponding to the tone flows through the current terminals GT₁ to GTₙ of the current control driver 303. Consequently, the tone designating current I_{DATA} modulated by the current mirror circuits M₁ to Mₙ flow through the current lines Y₁ to Yₙ and driving transistor 23.

The data driving circuit 307 applies the reset voltage V_{R} to the current lines Y₁ to Yₙ in the selection period T_{SE} in the fourth embodiment as well. Therefore, a first transistor 21 has both the function of a switching element which loads the reset voltage V_{R} into each of the pixel circuits D_{1,1} to D_{m,n}, and the function of a switching element which loads the tone designating current I_{DATA} into each of the pixel circuits D_{1,1} to D_{m,n}. Accordingly, the number of transistors necessary for the pixel circuits D_{1,1} to D_{m,n} does not increase. When organic EL elements E_{1,1} to E_{m,n} are formed on the same surface as the pixel circuits D_{1,1} to D_{m,n}, therefore, the aperture ratio of the pixels P_{1,1} to P_{m,n} does not decrease.

The present invention is not limited to the above embodiments, and various improvements and design changes can be made without departing from the spirit and scope of the present invention.

For example, an organic EL element is used as a light-emitting element in each of the above embodiments. However, another light-emitting element having rectification characteristics may also be used. That is, it is also possible to use a light-emitting element in which no electric current flows if a reverse bias voltage is applied and an electric current flows if a forward bias voltage is applied, and which emits light at luminance corresponding to the current value of the flowing electric current. An example of the light-emitting element having rectification characteristics is an LED (Light-Emitting Diode).

In addition, the tone designating current reference voltage V_{LOW} of the voltage supply driver 6 may also be positioned on the right side of the EL load border line corresponding to the maximum luminance tone shown in FIG. 4, provided that a portion or the whole of the tone designating current I_{DATA} does not flow through the organic EL elements in the selection period T_{SE}.

1. A display device comprising:
a plurality of selection scan lines;
a plurality of current lines;
a selection scan driver which sequentially selects said plurality of selection scan lines in each selection period;
a data driving circuit which applies a reset voltage to said plurality of current lines in a first part of the selection period, and supplies a designating current having a current value corresponding to an image signal to said plurality of current lines in a second part of the selection period after applying the reset voltage in the selection period; and
a plurality of pixel circuits which are connected to said plurality of selection scan lines and said plurality of current lines, and supply a driving current having a current value corresponding to the current value of the designating current which flows through said plurality of current lines.

2. An apparatus according to claim 1, wherein said data driving circuit comprises:
a switch which switches to a state in which the reset voltage is applied to said plurality of current lines in the first part of the selection period; and
a current source driver which supplies the designating current having the current value corresponding to the image signal after the reset voltage is applied by the switch within the selection period.

3. An apparatus according to claim 1, wherein
In the selection period, each of said plurality of pixel circuits loads the designating current which flows through said plurality of current lines, and stores a level of a voltage converted in accordance with the current value of the designating current, and
after the selection period, each of said plurality of pixel circuits shuts off the designating current which flows through said plurality of current lines, and supplies a driving current corresponding to the level of the voltage converted in accordance with the designating current.

4. An apparatus according to any one of claims 1 to 3, further comprising a plurality of light-emitting elements which are arranged at intersections of said plurality of selection scan lines and said plurality of current lines, emit light at luminance corresponding to a current value of a driving current, and each have two electrodes one of which is connected to a corresponding one of said plurality of pixel circuits.

5. An apparatus according to claim 4, wherein the reset voltage applied by the data driving circuit is set equal to or lower than a voltage of the other electrode of the light-emitting element.

6. An apparatus according to claim 1, further comprising:
a plurality of voltage supply lines; and
a voltage supply driver which sequentially selects said plurality of voltage supply lines in synchronism with the sequential selection of said plurality of selection scan lines by the selection scan driver.

7. An apparatus according to claim 6, wherein each of said pixel circuits comprises:
a first transistor having a gate connected to the selection scan line, and a drain and source one of which is connected to the current line;
a second transistor having a gate connected to the selection scan line, and a drain and source one of which is connected to the voltage supply line;
a driving transistor having a gate connected to the other of the drain and source of the second transistor, and a drain and source one of which is connected to the voltage supply line, and the other of which is connected to the other of the drain and source of the first transistor; and
a capacitor which stores a gate-to-one of source and drain voltage of the driving transistor by holding the voltage.

8. An apparatus according to claim 7, which further comprises a plurality of light-emitting elements which are arranged at intersections of said plurality of selection scan lines and said plurality of current lines, emit light at luminance corresponding to a current value of a driving current, and each have two electrodes one of which is connected to a corresponding one of said plurality pixel circuits, and
in which the other electrode of the light-emitting element is connected to the other of the drain and source of the driving transistor.

9. An apparatus according to claim 8, wherein
in the selection period, the first transistor supplies the designating current from the voltage supply line to the current line via the drain-to-source path of the driving transistor, the driving transistor converts the current value of the designating current into a level of a gate-to-one of source and drain voltage, and the capacitor stores the level of the converted voltage, and
after the selection period, the driving transistor supplies, to the light-emitting element, a driving current having a current value corresponding to the level of the gate-to-one of source and drain voltage stored by the capacitor.

10. An apparatus according to claim 8, wherein the voltage applied to the voltage supply line by the voltage supply driver in the selection period is set not higher than a voltage of the other electrode of the light-emitting element, and the voltage applied to the voltage supply line by the voltage supply driver after the selection period is set higher than the voltage of the other electrode of the light-emitting element.

11. A display device comprising:
a plurality of selection scan lines;
a plurality of current lines;
a plurality of light-emitting elements which are arranged at intersections of said plurality of selection scan lines and said plurality of current lines, and emit light at luminance corresponding to a current value of a driving current;
a selection scan driver which sequentially select said plurality of selection scan lines in each selection period;
a data driving circuit which applies a reset voltage to said plurality of current lines in a first part of the selection period, and supplies a designating current having a current value corresponding to an image signal to said plurality of current lines in a second part of the selection period after applying the reset voltage in the selection period; and
a plurality of pixel circuits which are connected to said plurality of selection scan lines and said plurality of current lines, and electrically connect said plurality of current lines and said plurality of light-emitting elements to each other in the selection period.

12. A data driving circuit of an active matrix driving display device comprising a plurality of light-emitting elements connected to a plurality of selection scan lines and a plurality of current lines, a selection scan driver which sequentially selects said plurality of selection scan lines in each selection period, and a plurality of pixel circuits connected to said plurality of light-emitting elements,
wherein a reset voltage is applied to said plurality of current lines in a first part of the selection period, and a designating current having a current value corresponding to an image signal is supplied to said plurality of current lines in a second part of the selection period after the first part of the selection period.

13. A circuit according to claim 12, further comprising:
a switch which switches to a state in which the reset voltage is applied to said plurality of current lines in the first part of the selection period; and
a current source driver which, after the reset voltage is applied by the switch in the selection period, supplies the designating current having the current value corresponding to the image signal to said plurality of current lines.

14. A display panel driving method comprising:
a selection step of sequentially selecting a plurality of selection scan lines of a display panel comprising a plurality of pixel circuits connected to the plurality of selection scan lines and a plurality of current lines, and a plurality of light-emitting elements which are arranged at intersections of the plurality of selection scan lines and the plurality of current lines, each of the light-emitting elements emits light at luminance corresponding to a current value of a current flowing the current line; and
a reset step of applying a reset voltage to the plurality of current lines in an initial part of a period in which each of the plurality of selection scan lines is selected.

15. A method according to claim 14, further comprising:
a designating current supply step of, after the reset step, supplying designating currents having current value corresponding to an image signal to the plurality of current lines, and storing, in the plurality of pixel circuits, the current value of the designating currents flowing through the plurality of current lines; and
a light emission step of, after the designating current supply step, allowing the plurality of pixel circuits to supply, to the plurality of light-emitting elements, driving currents having current value corresponding to the stored current value of the designating currents.
